(19) United States
(12) Patent Application Publication
(10) Pub. No.: US 2026/0127218 A1
(43) Pub. Date: May 7, 2026

(54) SYNTHETIC DATA GENERATION SYSTEM AND NON-TRANSITORY RECORDING MEDIUM CONTAINING SYNTHETIC DATA GENERATION PROGRAM

(71) Applicant: SUBARU CORPORATION, Tokyo (JP)

(72) Inventor: Shumpei KOBAYASHI, Tokyo (JP)

(21) Appl. No.: 19/364,624

(22) Filed: Oct. 21, 2025

(30) Foreign Application Priority Data
Nov. 7, 2024 (JP) 2024-195052

(51) Int. Cl. G06F 16/432; G06F 16/438

(52) U.S. Cl. CPC G06F 16/434; G06F 16/438

(57) ABSTRACT

A synthetic data generation system includes a first learning model, a second learning model, and a processor. The first learning model outputs synthetic data upon receiving one or more first data items and a second data item. The synthetic data is a combination of the one or more first data items or one or more third data items corresponding to the one or more first data items and the second data item or a fourth data item corresponding to the second data item. The second learning model outputs a determination result upon receiving the synthetic data and a determination reference. The determination result is a result of a determination regarding the synthetic data based on the determination reference. The processor determines whether the determination result satisfies a selection reference, and causes a plurality of pieces of the synthetic data satisfying the selection reference to be displayed in a list form.

### CROSS-REFERENCE TO RELATED APPLICATIONS

The present application claims priority from Japanese Patent Application No. 2024-195052 filed on November 7, 2024, the entire contents of which are hereby incorporated by reference.

### BACKGROUND

The disclosure relates to a synthetic data generation system and a non-transitory recording medium containing a synthetic data generation program.

Automobile designers want artificial intelligence (AI) to produce novel design ideas satisfying feasibility of an item to be designed. Japanese Unexamined Patent Application Publication (JP-A) No. 2021-168078 discloses AI configured to produce novel design by combining an image of an item that a user wants to design and an image of a natural object, for example.

### SUMMARY

An aspect of the disclosure provides a synthetic data generation system including a first learning model, a second learning model, and a processor. The first learning model is configured to output synthetic data upon receiving one or more first data items and a second data item. The synthetic data is a combination of the one or more first data items or one or more third data items corresponding to the one or more first data items and the second data item or a fourth data item corresponding to the second data item. The second learning model is configured to output a determination result upon receiving the synthetic data acquired from the first learning model and a determination reference. The determination result is a result of a determination regarding the synthetic data based on the determination reference. The processor is configured to determine whether the determination result satisfies a predetermined selection reference, and perform data processing to cause a plurality of pieces of the synthetic data satisfying the predetermined selection reference to be displayed in a list form.

An aspect of the disclosure provides a non-transitory computer readable recording medium containing a synthetic data generation program that causes, when executed by a computer, the computer to implement a method. The method includes: receiving one or more first data items and a second data item; acquiring synthetic data from a first learning model by sending the one or more first data items and the second data item to the first learning model, the synthetic data being a combination of the one or more first data items or one or more third data items corresponding to the one or more first data items and the second data item or a fourth data item corresponding to the second data item; acquiring a determination result regarding the synthetic data determined based on a determination reference from a second learning model by sending the synthetic data acquired from first learning model and the determination reference to the second learning model; and determining whether the determination result satisfies a predetermined selection reference, and performing data processing that causes a plurality of pieces of the synthetic data satisfying the predetermined selection reference to be displayed in a list form.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a block diagram illustrating an exemplary operation of a synthetic data generation system according to one example embodiment of the disclosure.

FIG. 2 is a diagram illustrating an example of a learning model included in a generative AI unit illustrated in FIG. 1.

FIG. 3 is a diagram illustrating an example of the learning model included in the generative AI unit illustrated in FIG. 1.

FIG. 4 is a diagram illustrating an example of the learning model included in the generative AI unit illustrated in FIG. 1.

FIG. 5 is a diagram illustrating an example of reference data illustrated in FIG. 1.

FIG. 6 is a diagram illustrating an example of a learning model included in a filter unit illustrated in FIG. 1.

FIG. 7 is a diagram illustrating an example of an interface of a list display illustrated in FIG. 1.

FIG. 8 is a diagram illustrating an example of the interface of the list display illustrated in FIG. 1.

FIG. 9 is a block diagram illustrating a modification example of the operation of the synthetic data generation system illustrated in FIG. 1.

FIG. 10 is a diagram illustrating an example of a learning model included in a generative AI unit illustrated in FIG. 9.

FIG. 11 is a diagram illustrating an example of the learning model included in the generative AI unit illustrated in FIG. 9.

FIG. 12 is a diagram illustrating an example of the learning model included in the generative AI unit illustrated in FIG. 9.

FIG. 13 is a block diagram illustrating a modification example of the operation of the synthetic data generation system illustrated in FIG. 1.

FIG. 14 is a diagram illustrating exemplary data conversion at a data converter illustrated in FIG. 13.

FIG. 15 is a diagram illustrating exemplary data conversion at the data converter illustrated in FIG. 13.

FIG. 16 is a diagram illustrating exemplary data conversion at the data converter illustrated in FIG. 13.

FIG. 17 is a block diagram illustrating a modification example of the operation of the synthetic data generation system illustrated in FIG. 1.

FIG. 18 is a block diagram illustrating a modification example of the operation of the synthetic data generation system illustrated in FIG. 1.

FIG. 19 is a diagram illustrating an exemplary schematic configuration of the synthetic data generation system illustrated in FIG. 1.

FIG. 20 is a flowchart of an exemplary list display procedure to be performed by the synthetic data generation system illustrated in FIG. 19.

FIG. 21 is a diagram illustrating a modification example of the schematic configuration of the synthetic data generation system illustrated in FIG. 13.

FIG. 22 is a flowchart of an exemplary list display procedure to be performed by the synthetic data generation system illustrated in FIG. 21.

FIG. 23 is a diagram illustrating a modification example of the schematic configuration of the synthetic data generation system illustrated in FIG. 1.

FIG. 24 is a diagram illustrating a modification example of the schematic configuration of the synthetic data generation system illustrated in FIG. 13.

FIG. 25 is a block diagram illustrating an exemplary operation of a synthetic data generation system according to one example embodiment of the disclosure.

FIG. 26 is a diagram illustrating an example of an interface of a selection flag register illustrated in FIG. 25.

FIG. 27 is a diagram illustrating an example of the interface of the selection flag register illustrated in FIG. 25.

FIG. 28 is a diagram illustrating an example of reference data illustrated in FIG. 25.

FIG. 29 is a diagram illustrating an example of a learning model included in a filter unit illustrated in FIG. 25.

FIG. 30 is a diagram illustrating an example of an interface of a list display illustrated in FIG. 25.

FIG. 31 is a diagram illustrating an example of the interface of the list display illustrated in FIG. 25.

FIG. 32 is a block diagram illustrating a modification example of the exemplary operation of the synthetic data generation system illustrated in FIG. 25.

FIG. 33 is a block diagram illustrating a modification example of the exemplary operation of the synthetic data generation system illustrated in FIG. 25.

FIG. 34 is a diagram illustrating an exemplary schematic configuration of the synthetic data generation system illustrated in FIG. 25.

FIG. 35 is a flowchart of an exemplary list display procedure to be performed by the synthetic data generation system illustrated in FIG. 34.

FIG. 36 is a diagram illustrating a modification example of the schematic configuration of the synthetic data generation system illustrated in FIG. 33.

FIG. 37 is a flowchart of an exemplary list display procedure to be performed by the synthetic data generation system illustrated in FIG. 36.

FIG. 38 is a diagram illustrating a modification example of the schematic configuration of the synthetic data generation system illustrated in FIG. 25.

FIG. 39 is a diagram illustrating a modification example of the schematic configuration of the synthetic data generation system illustrated in FIG. 33.

FIG. 40 is a block diagram illustrating an exemplary operation of a synthetic data generation system according to one example embodiment of the disclosure.

FIG. 41 is a block diagram illustrating a modification example of the exemplary operation of the synthetic data generation system illustrated in FIG. 40.

FIG. 42 is a diagram illustrating an exemplary schematic configuration of the synthetic data generation system illustrated in FIG. 40.

FIG. 43 is a flowchart of an exemplary list display procedure to be performed by the synthetic data generation system illustrated in FIG. 42.

FIG. 44 is a diagram illustrating an exemplary schematic configuration of the synthetic data generation system illustrated in FIG. 41.

FIG. 45 is a flowchart of an exemplary list display procedure to be performed by the synthetic data generation system illustrated in FIG. 44.

FIG. 46 is a diagram illustrating a modification example of the schematic configuration of the synthetic data generation system illustrated in FIG. 40.

FIG. 47 is a diagram illustrating a modification example of the schematic configuration of the synthetic data generation system illustrated in FIG. 41.

### DETAILED DESCRIPTION

### 1. Background

Automobile designers want artificial intelligence (AI) to produce novel design ideas satisfying feasibility of an item to be designed. JP-A No. 2021-168078 discloses AI configured to produce an item by combining an image of an item that a user wants to design and an image of a natural object.

According to the technology disclosed in JP-A No. 2021-168078, a learning model (a first generator 21) is a model obtained through machine learning based on a plurality of images x of a natural object, which corresponds to an explanatory variable, and a plurality of images y of an artificial object, which corresponds to a dependent variable. Using a first identifier 23 configured to determine whether an image y' generated by the first generator 21 is an image of a real artificial object, the first generator 21 is optimized in parameters to generate the image y' that is close enough to a real artificial object to fool the first identifier 23, in a learning stage.

According to the technology disclosed in JP-A No. 2021-168078, in response to input of an image of a natural object to the first generator 21, a design close to a real artificial object is obtained by combining the natural object and the artificial object. In this respect, the first generator 21 is regarded as an excellent generative AI. However, the first generator 21, which is prevented from producing an infeasible design quite different from an item that the user wants to design, is only capable of producing a passable design without novelty.

One possible measure to obtain a novel design with the technology disclosed in JP-A No. 2021-168078 is to learn a learning model without using the first identifier 23. In this case, however, the AI generates an infeasible design quite different from the item that the user wants to design. The use of such AI can be ineffective for the user in creating ideas. It is desirable to provide a synthetic data generation system and a synthetic data generation program each configured to present the user with a design effective in creating ideas.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 2. First Example Embodiment

### Configuration Example

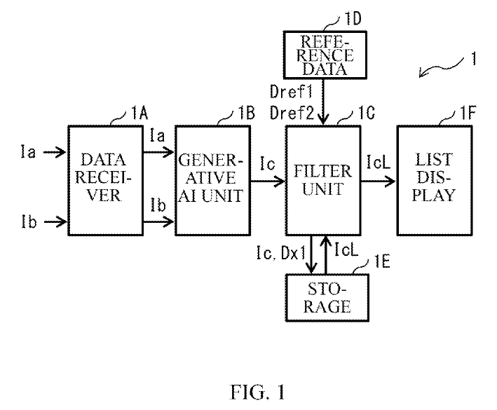

First, a description is given of a synthetic data generation system 1 according to a first example embodiment of the disclosure. FIG. 1 is a block diagram illustrating an exemplary operation of the synthetic data generation system 1. As illustrated in FIG. 1, for example, the synthetic data generation system 1 may include a data receiver 1A, a generative AI unit 1B, a filter unit 1C, reference data 1D, a storage 1E, and a list display 1F. In one embodiment, the synthetic data generation system 1 may serve as a "synthetic data generation system". In one embodiment, the generative AI unit 1B may serve as a "first learning model". In one embodiment, the filter unit 1C may serve as a "second learning model" and a "processor".

The data receiver 1A may include an interface configured to receive input of natural object data Ia and artificial object data Ib. The natural object data Ia and the artificial object data Ib sharing a common data format may be input to the data receiver 1A. The data receiver 1A may be configured to output the natural object data Ia and the artificial object data Ib thus received to the generative AI unit 1B. The natural object data Ia and the artificial object data Ib may be image-related data. In one embodiment, the natural object data Ia may serve as a "first data item". In one embodiment, the artificial object data Ib may serve as a "second data item". In one embodiment, a natural object may serve as a "first target object". In one embodiment, the artificial object may serve as a "second target object".

The natural object data Ia may be, for example, natural object 2D image data Ia1, natural object 3D image data Ia2, or natural object 3D model data. The natural object may be an object existing in nature, rather than an artificial or human-made object. Non-limiting examples of the natural object may include animals such as dogs and cats. The natural object 2D image data Ia1 may be two-dimensional image data including a natural object, and may be, for example, image data on a natural object captured by a monocular camera. The natural object 3D image data Ia2 may be three-dimensional object including a natural object, and may be, for example, image data on a natural object captured by a three-dimensional camera. The natural object 3D model data may be three-dimensional model data including a natural object, and may be, for example, three-dimensional computer-aided design (CAD) data including a natural object.

The artificial object data Ib may be, for example, artificial object 2D image data Ib1, artificial object 3D image data Ib2, or artificial object 3D model data. The artificial object may be an object artificially manufactured or built. Non-limiting examples of artificial objects may include vehicle wheels. The artificial object 2D image data Ib1 may be two-dimensional image data including an artificial object, and may be, for example, image data on an artificial object captured by a monocular camera. The artificial object 3D image data Ia2 may be three-dimensional image data including an artificial object, and may be, for example, image data on an artificial object captured by a three-dimensional camera. The artificial object 3D model data may be three-dimensional model data including an artificial object, and may be, for example, three-dimensional CAD data including an artificial object.

The generative AI unit 1B may include a learning model 11. The learning model 11 is configure to, upon receiving the natural object data Ia and the artificial object data Ib, generate and output synthetic data Ic by combining the natural object data Ia and the artificial object data Ib with each other. The generative AI unit 1B may be configured to output the synthetic data Ic generated by the learning model 11 to the filter unit 1C. In one embodiment, the learning model 11 may serve as the "first learning model". In one embodiment, the synthetic data Ic may serve as "synthetic data". The synthetic data Ic may be data sharing a common data format with the natural object data Ia and the artificial object data Ib and including a product generated by combining the natural object and the artificial object with each other. For example, when the natural object is a dog and the artificial object is a vehicle wheel, the product may be a combination of the dog and the vehicle wheel.

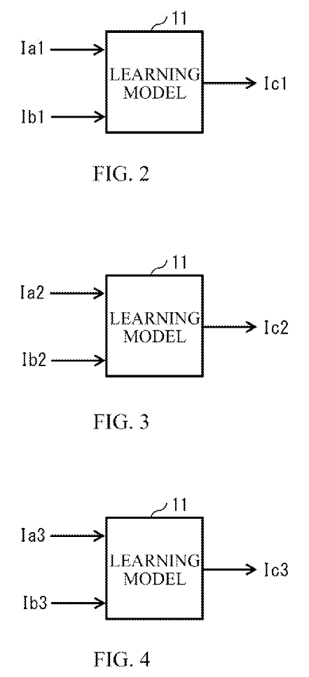

As illustrated in FIG. 2, for example, the learning model 11 may be configured to, upon receiving the natural object 2D image data Ia1 and the artificial object 2D image data Ib1, generate and output product 2D image data Ic1 by combining the natural object 2D image data Ia1 and the artificial object 2D image data Ib1 with each other. The learning model 11 may be configured to generate and output the product 2D image data Ic1, every time the natural object 2D image data Ia1 and the artificial object 2D image data Ib1 are received.

As illustrated in FIG. 3, for example, the learning model 11 may be configured to, upon receiving the natural object 3D image data Ia2 and artificial object 3D image data Ib2, generate and output product 3D image data Ic2 by combining the natural object 3D image data Ia2 and the artificial object 3D image data Ib2 with each other. The learning model 11 may be configured to generate and output the product 3D image data Ic2, every time the natural object 3D image data Ia2 and the artificial object 3D image data Ib2 are received.

As illustrated in FIG. 4, for example, the learning model 11 may be configured to, upon receiving the natural object 3D model data Ia3 and the artificial object 3D model data Ib3, generate and output product 3D model data Ic3 by combining the natural object 3D model data Ia3 and the artificial object 3D model data Ib3 with each other. The learning model 11 may be configured to generate and output the product 3D model data Ic3, every time the natural object 3D model data Ia3 and the artificial object 3D model data Ib3 are received.

The learning model 11 may be a model including, for example, deep learning. The learning model 11 is a model trained based on teaching data including, for example, natural object data Ia_test, artificial object data Ib_test, and synthetic data Ic_test. The natural object data Ia_test may be data sharing a common data format with the natural object data Ia and including a natural object. The artificial object data Ib_test may be data sharing a common data format with the artificial object data Ib and including an artificial object. The synthetic data Ic_test may be data sharing a common data format with the synthetic data Ic and including a product.

The reference data 1D may be a data group to be used by the filter unit 1C. As illustrated in FIG. 5, for example, the reference data 1D may include a determination reference Dref1 and a selection reference Dref2. In one embodiment, the determination reference Dref1 may serve as a "determination reference". In one embodiment, the selection reference Dref2 may serve as a "selection reference".

The determination reference Dref1 may include terms indicating likelihood of the product included in the synthetic data Ic being an artificial object. Non-limiting examples of the terms may include "Car Wheel" and "Not Car Wheel". The selection reference Dref2 may include a first selection reference indicating the product included in the synthetic data Ic does not look like an artificial object, and a second selection reference indicating that the product included in the synthetic data Ic looks like an artificial object. The selection reference Dref2 may include, for example, a score threshold (e.g., 55% or less) of "Not Car Wheel" as the first selection reference, and a score threshold (e.g., 70% or less) of "Car Wheel" as the second selection reference.

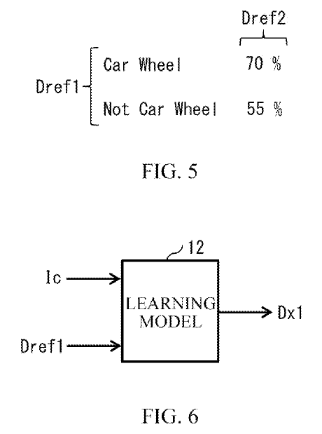

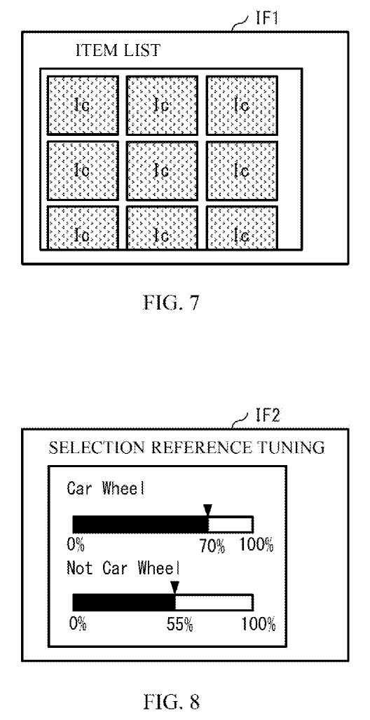

The filter unit 1C may be configured to perform filtering based on the reference data 1D on the synthetic data Ic obtained by the generative AI unit 1B. The filter unit 1C may be configured to, if the synthetic data Ic is determined to satisfy a requirement indicated by the reference data 1D as a result of the filtering, correlate the synthetic data Ic with the result of the filtering (a determination result Dx1) and store the synthetic data Ic in the storage 1E. The filter unit 1C may include a learning model 12. As illustrated in FIG. 6, for example, the learning model 12 may be configured to, upon receiving the synthetic data Ic and the determination reference Dref1, output the determination result Dx1 regarding the synthetic data Ic determined based on the determination reference Dref1. In one embodiment, the learning model 12 may serve as the "second learning model". In one embodiment, the determination result Dx1 may serve as a "determination result". The determination result Dx1 may include, for example, a score value of "Not Car Wheel" in the synthetic data Ic and a score value of "Car Wheel" in the synthetic data Ic.

The learning model 12 may be a model including contrastive language-image pretraining (CLIP), for example. The learning model 12 may be a model trained based on teaching data including, for example, the synthetic data Ic_test, the determination reference Dref1, and determination result Dx1_test. The synthetic data Ic_test may be data sharing a common data format with the synthetic data Ic and including a product. The determination result Dx1_test may be data sharing a common data format with the determination result Dx1 and including a CLIP score value, for example.

The filter unit 1C may be configured to determine whether the determination result Dx1 obtained by the learning model 12 satisfies the selection reference Dref2. The filter unit 1C may be configured to, if the determination result Dx1 satisfies the selection reference Dref2, correlate the synthetic data Ic with the determination result Dx1 and store the synthetic data Ic in the storage 1E. The filter unit 1C may be configured to perform the filtering based on the reference data 1D and determine whether the determination result Dx1 satisfies the selection reference Dref2, every time the synthetic data Ic is received. In this way, the filter unit 1C may be configured to store the synthetic data Ic satisfying the selection reference Dref2 in the storage 1E.

The filter unit 1C may be configured to output the plurality of pieces of the synthetic data Ic satisfying the selection reference Dref2 and stored in the storage 1E, as a synthetic data list IcL to the list display 1F. In some embodiments, the filter unit 1C may be configured to generate thumbnail data of each piece of the synthetic data Ic satisfying the selection reference Dref2 and read from the storage 1E, and output the synthetic data list IcL including a plurality of pieces of the thumbnail data thus generated to the list display 1F. In this way, the filter unit 1C may be configured to perform the data processing to cause the plurality of pieces of the synthetic data Ic satisfying the selection reference Dref2 to be displayed in a list form.

The filter unit 1C may be configured to output the synthetic data list IcL to the list display 1F at a predetermined timing. In some embodiments, the filter unit 1C may be configured to output the synthetic data list IcL to the list display 1F when a request is received from a user of the synthetic data generation system 1 or every time the synthetic data Ic satisfying the selection reference Dref2 is stored in the storage 1E.

As illustrated in FIG. 7, for example, the list display 1F may be configured to, upon receiving the synthetic data list IcL, generate an interface IF1 including an image of a list of the plurality of pieces of the synthetic data Ic included in the synthetic data list IcL thus received. In some embodiments, the interface IF1 may be configured to display the synthetic data Ic selected by the user in an enlarged manner. In some embodiments, the interface IF1 may be configured to generate a selection flag corresponding to the synthetic data Ic selected by the user, correlate the selection flag with the synthetic data Ic selected by the user from the plurality of pieces of the synthetic data IC included in the storage 1E, and store the selection flag in the storage 1E.

In some embodiments, as illustrated in FIG. 8, for example, the filter unit 1C in the synthetic data generation system 1 may be configured to generate an interface IF2 with which the score threshold of the first selection reference ("Car Wheel") or the score threshold of the second selection reference ("Not Car Wheel") are adjustable. In this case, the interface IF2 may be configured to adjust the score threshold of the first selection reference ("Car Wheel") and the score threshold of the second selection reference ("Not Car Wheel") in response to user input, for example. The filter unit 1C may be configured to, when the score threshold of the first selection reference ("Car Wheel") and the score threshold of the second selection reference ("Not Car Wheel") are adjusted, update the reference data 1D with the adjusted thresholds.

### Effects

Next, a description is given of effects of the synthetic data generation system 1.

According to the present example embodiment, upon receiving the natural object data Ia and the artificial object data Ib1, the learning model 11 outputs the synthetic data Ic by combining the natural object data Ia and the artificial object data Ib1 thus received with each other. Upon receiving the synthetic data Ic and the determination reference Dref1, the learning model 12 outputs the determination result Dx1 regarding the synthetic data Ic determined based on the determination reference Dref1. Thereafter, the filter unit 1C determines whether the determination result Dx1 satisfies the selection reference Dref2, and performs the data processing to cause the plurality of pieces of the synthetic data Ic satisfying the selection reference Dref2 to be displayed in a list form. This makes it possible to exclude an infeasible design quite different from the artificial object (item) that the user wants to design or a passable design without novelty in advance before the list is displayed. As a result, it is possible to present the user with a design effective in creating ideas.

In the present example embodiment, the synthetic data Ic correlated with the determination result Dx1 may be held in the storage 1E. This makes it possible to cause the synthetic data Ic newly acquired to be displayed in a list form together with the plurality of pieces of the synthetic data Ic determined to satisfy the selection reference Dref2 in the past determination result Dx1. As a result, it is possible to present the user with a plurality of designs (synthetic data Ic) effective in creating ideas.

### 3. Modification Examples of First Example Embodiment

Next, a description is given of modification examples of the synthetic data generation system 1.

### Modification Example A

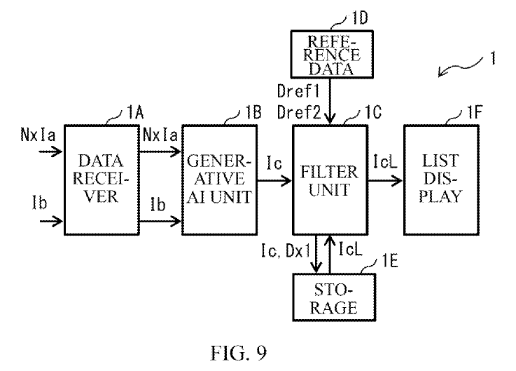

FIG. 9 is a block diagram illustrating a modification example of the operation of the synthetic data generation system 1. As illustrated in FIG. 9, for example, the synthetic data generation system 1 may be configured to receive a plurality of pieces (N-pieces) of the natural object data Ia at the data receiver 1A. In one embodiment, the plurality of pieces (N-pieces) of the natural object data Ia may serve as "first data items". The plurality of pieces (N-pieces) of the natural object data Ia may include natural objects different from one another. When two pieces of the natural object data Ia are received by the data receiver 1A, the natural object included in one of the two pieces of the natural object data Ia received by the data receiver 1A may be, for example, a dog, and the natural object included in the other piece of the natural object data Ia may be, for example, a cat.

In the present modification example, the data receiver 1A may include an interface configured to receive input of a plurality of pieces (N-pieces) of the natural object data Ia and one piece of the artificial object data Ib. The data receiver 1A may be configured to send the plurality of pieces (N-pieces) of the natural object data Ia and the one piece of the artificial object data Ib thus received to the generative AI unit 1B. The learning model 11 in the generative AI unit 1B may be configured to, upon receiving the plurality of pieces (N-pieces) of the natural object data Ia and the one piece of the artificial object data Ib, generate and output the synthetic data Ic by combining the plurality of pieces (N-pieces) of the natural object data Ia and the one piece of the artificial object data Ib with each other. In the present modification example, the learning model 11 may be a model trained based on teaching data including, for example, a plurality of pieces (N-pieces) of the natural object data Ia_test, one piece of the artificial object data Ib_test, and one piece of the synthetic data Ic_test.

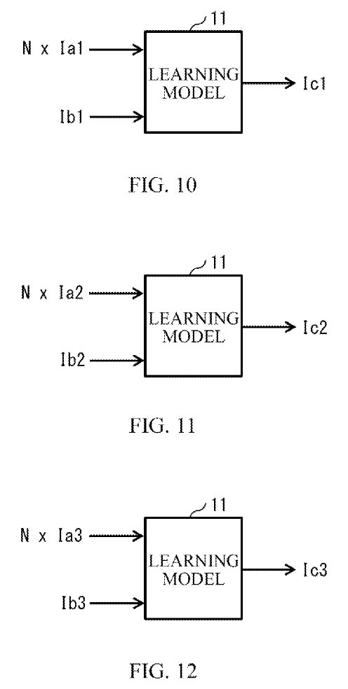

As illustrated in FIG. 10, for example, the learning model 11 may be configured to, upon receiving a plurality of pieces (N-pieces) of the natural object 2D image data Ia1 and one piece of the artificial object 2D image data Ib1, generate and output the product 2D image data Ic1 by combining the plurality of pieces (N-pieces) of the natural object 2D image data Ia1 and the one piece of the artificial object 2D image data Ib1 thus received with each other. The learning model 11 may be configured to generate and output the product 2D image data Ic1, every time the plurality of pieces (N-pieces) of the natural object 2D image data Ia1 and the artificial object 2D image data Ib1 are received.

As illustrated in FIG. 11, for example, the learning model 11 may be configured to, upon receiving a plurality of pieces (N-pieces) of the natural object 3D image data Ia2 and one piece of the artificial object 3D image data Ib2, generate and output the product 3D image data Ic2 by combining the plurality of pieces (N-pieces) of the natural object 3D image data Ia2 and the one piece of the artificial object 3D image data Ib2 thus received with each other. In some embodiments, the learning model 11 may be configured to generate and output the product 3D image data Ic2, every time the plurality of pieces (N-pieces) of the natural object 3D image data Ia2 and the one piece of the artificial object 3D image data Ib2 are received.

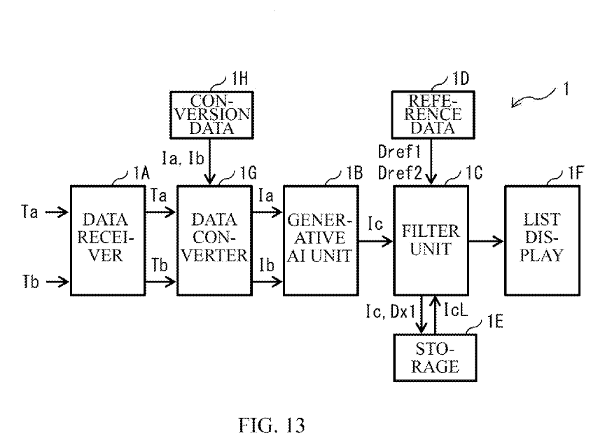

As illustrated in FIG. 12, for example, the learning model 11 may be configured to, upon receiving a plurality of pieces (N-pieces) of the natural object 3D model data Ia3 and one piece of the artificial object 3D model data Ib3, generate and output the product 3D model data Ic3 by combining the plurality of pieces (N-pieces) of the natural object 3D model data Ia3 and the one piece of the artificial object 3D model data Ib3 thus received with each other. The learning model 11 may be configured to generate and output the product 3D model data Ic3, every time the plurality of pieces (N-pieces) of the natural object 3D model data Ia3 and the one piece of the artificial object 3D model data Ib3 are received.

The product included in the synthetic data Ic may be a combination of the natural objects included in the plurality of pieces (N-pieces) of the natural object data Ia and the artificial object included in the artificial object data Ib. When two pieces of the natural object data Ia are received by the generative AI unit 1B, one of the two pieces of the natural object data Ia received by the generative AI unit 1B may include, for example, a dog, and the other piece of the natural object data Ia may include, for example, a cat. Further, the artificial object data Ib may include a vehicle wheel. In this case, the product included in the synthetic data Ic may be a combination of the dog, the cat, and the vehicle wheel.

In the present modification example, the plurality of pieces (N-pieces) of the natural object data Ia and the one piece of the artificial object data Ib may be received by the generative AI unit 1B. It is therefore possible to effectively create a further novel design and present the user with a design effective in creating ideas.

### Modification Example B

FIG. 13 is a block diagram illustrating a modification example of the operation of the synthetic data generation system 1. As illustrated in FIG. 13, for example, the synthetic data generation system 1 may include an interface allowing natural object data Ta and artificial object data Tb to be received at the data receiver 1A. The natural object data Ta and the artificial object data Tb sharing a common data format with each other may be input to the data receiver 1A. The data receiver 1A may be configured to send the natural object data Ta and the artificial object data Tb thus received to a data converter 1G. In one embodiment, the natural object data Ta may serve as "first text data". In one embodiment, the artificial object data Tb may serve as "second text data".

The natural object data Ta may be text data representing a natural object. Non-limiting examples of the text data representing the natural object may include DOG and CAT. The artificial object data Tb may be text data representing an artificial object. Non-limiting examples of the text data representing the artificial object may include WHEEL.

In the present modification example, the synthetic data generation system 1 may further include the data converter 1G and conversion data 1H, as illustrated in FIG. 13, for example. The data converter 1G may be configured to, upon receiving the natural object data Ta and the artificial object data Tb, convert the natural object data Ta and the artificial object data Tb thus received into the natural object data Ia and the artificial object data Ib, respectively, using the conversion data 1H. The data converter 1G may be configured to output the natural object data Ia and the artificial object data Ib obtained as a result of the conversion to the generative AI unit 1B.

In the conversion data 1H, the natural object data Ia may be held in correlation with the natural object data Ta, and the artificial object data Ib may be held in correlation with the artificial object data Tb. The data converter 1G may be configured to, upon receiving the natural object data Ta, extract the natural object data Ia corresponding to the natural object data Ta thus received, from the conversion data 1H. The data converter 1G may be configured to, upon receiving the artificial object data Tb, extract the artificial object data Ib corresponding to the artificial object data Tb thus received, from the conversion data 1H.

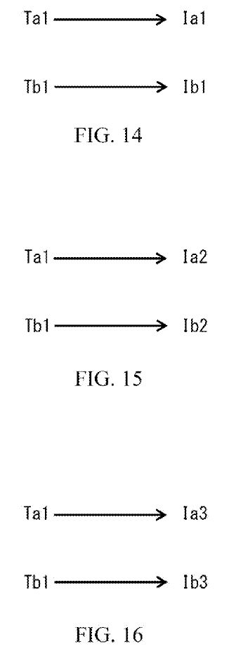

As illustrated in FIG. 14, for example, the data converter 1G may be configured to, upon receiving natural object text data Ta1 and artificial object text data Tb1, convert the natural object text data Ta1 and the artificial object text data Tb1 thus received into the natural object 2D image data Ia1 and the artificial object 2D image data Ib1, respectively, using the conversion data 1H. The natural object text data Ta1 may be text data representing a natural object. The artificial object text data Tb1 may be text data representing an artificial object. The data converter 1G may be configured to convert the natural object text data Ta1 and the artificial object text data Tb1 thus received into the natural object 2D image data Ia1 and the artificial object 2D image data Ib1, respectively, using the conversion data 1H, every time the natural object text data Ta1 and the artificial object text data Tb1 are received.

As illustrated in FIG. 15, for example, the data converter 1G may be configured to, upon receiving the natural object text data Ta1 and the artificial object text data Tb1, convert the natural object text data Ta1 and the artificial object text data Tb1 thus received into the natural object 3D image data Ia2 and the artificial object 3D image data Ib2, respectively, using the conversion data 1H. The data converter 1G may be configured to convert the natural object text data Ta1 and the artificial object text data Tb1 thus received into the natural object 3D image data Ia2 and the artificial object 3D image data Ib2, respectively, using the conversion data 1H, every time the natural object text data Ta1 and the artificial object text data Tb1 are received.

As illustrated in FIG. 16, for example, the data converter 1G may be configured to, upon receiving the natural object text data Ta1 and the artificial object text data Tb1, convert the natural object text data Ta1 and the artificial object text data Tb1 thus received into the natural object 3D model data Ia3 and the artificial object 3D model data Ib3, respectively, using the conversion data 1H. The data converter 1G may be configured to convert the natural object text data Ta1 and the artificial object text data Tb1 thus received into the natural object 3D model data Ia3 and the artificial object 3D model data Ib3, respectively, using the conversion data 1H, every time the natural object text data Ta1 and the artificial object text data Tb1 are received.

In the present modification example, the natural object data Ta and the artificial object data Tb received by the data receiver 1A may be converted into the natural object data Ia and the artificial object data Ib, respectively, at the data converter 1G. Thereafter, the natural object data Ia and the artificial object data Ib obtained as a result of the conversion may be sent to the generative AI unit 1B. This allows the user to acquire the synthetic data Ic by simply inputting text data. As a result, it is possible to reduce the time and effort of the user in inputting data, and to present the user with a design effective in creating ideas.

### Modification Example C

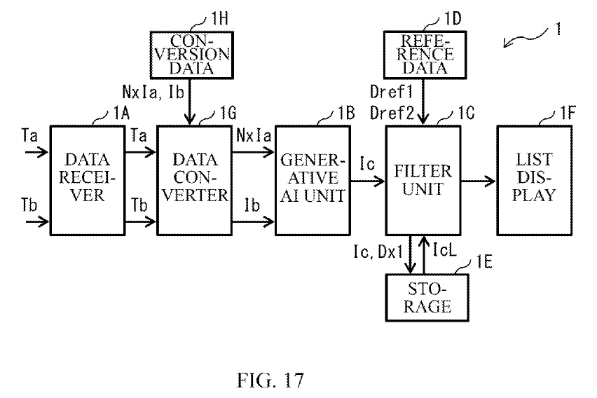

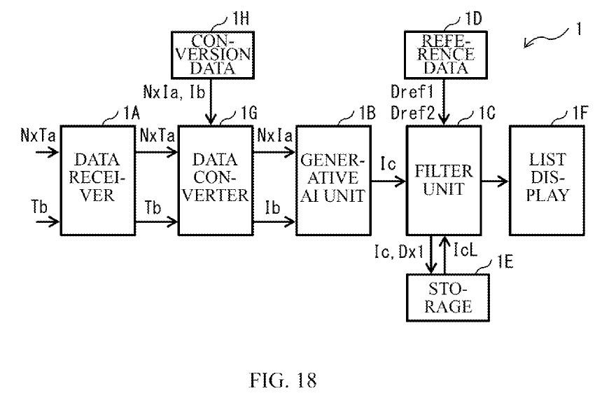

FIG. 17 is a block diagram illustrating a modification example of the operation of the synthetic data generation system 1. As illustrated in FIG. 17, for example, the synthetic data generation system 1 may be configured to convert the natural object data Ta into a plurality of pieces (N-pieces) of the natural object data Ia at the data converter 1G, using the conversion data 1H in Modification Example B. In this case, the data converter 1G may be configured to output the plurality of pieces (N-pieces) of the natural object data Ia and the one piece of the artificial object data Ib obtained as a result of the conversion to the generative AI unit 1B.

The plurality of pieces (N-pieces) of the natural object data Ia may include respective natural objects different from one another. When two pieces of the natural object data Ia are received by the data converter 1G, one of the two pieces of the natural object data Ia received by the data converter 1G may include, for example, a dog, and the other piece of the natural object data Ia may include, for example, a cat.

The data converter 1G may be configured to, upon receiving the natural object text data Ta1 and the artificial object text data Tb1, for example, convert the natural object text data Ta1 and the artificial object text data Tb1 thus received into a plurality of pieces (N-pieces) of the natural object 2D image data Ia1 and one piece of the artificial object 2D image data Ib1, using the conversion data 1H. The data converter 1G may be configured to convert the natural object text data Ta1 and the artificial object text data Tb1 thus received into the plurality of pieces (N-pieces) of the natural object 2D image data Ia1 and the one piece of the artificial object 2D image data Ib1, using the conversion data 1H, every time the natural object text data Ta1 and the artificial object text data Tb1 are received.

The data converter 1G may be configured to, upon receiving the natural object text data Ta1 and the artificial object text data Tb1, for example, convert the natural object text data Ta1 and the artificial object text data Tb1 thus received into a plurality of pieces (N-pieces) of the natural object 3D image data Ia2 and one piece of the artificial object 3D image data Ib2, using the conversion data 1H. In some embodiments, the data converter 1G may be configured to convert the natural object text data Ta1 and the artificial object text data Tb1 thus received into the plurality of pieces (N-pieces) of the natural object 3D image data Ia2 and the one piece of the artificial object 3D image data Ib2, using the conversion data 1H, every time the natural object text data Ta1 and the artificial object text data Tb1 are received.

The data converter 1G may be configured to, upon receiving the natural object text data Ta1 and the artificial object text data Tb1, for example, convert the natural object text data Ta1 and the artificial object text data Tb1 thus received into a plurality of pieces (N-pieces) of the natural object 3D model data Ia3 and one piece of the artificial object 3D model data Ib3, using the conversion data 1H. The data converter 1G may be configured to convert the natural object text data Ta1 and the artificial object text data Tb1 thus received into the plurality of pieces (N-pieces) of the natural object 3D model data Ia3 and the one piece of the artificial object 3D model data Ib3, using the conversion data 1H, every time the natural object text data Ta1 and the artificial object text data Tb1 are received.

In the present modification example, the generative AI unit 1B (the learning model 11) may be configured to, upon receiving the plurality of pieces (N-pieces) of the natural object data Ia and the one piece of the artificial object data Ib, generate and output the synthetic data Ic by combining the plurality of pieces (N-pieces) of the natural object data Ia and the one piece of the artificial object data Ib with each other. In the present modification example, the learning model 11 may be a model trained based on teaching data including, for example, a plurality of pieces (N-pieces) of the natural object data Ia_test, one piece of the artificial object data Ib_test, and one piece of the synthetic data Ic_test.

In the present modification example, the natural object data Ta may be converted into the plurality of pieces (N-pieces) of the natural object data Ia at the data converter 1G, using the conversion data 1H. It is therefore possible to effectively create a further novel design and present the user with a design effective in creating ideas.

### Modification Example D

FIG. 18 is a block diagram illustrating a modification example of the operation of the synthetic data generation system 1. As illustrated in FIG. 18, for example, the synthetic data generation system 1 may be configured to receive a plurality of pieces (N-pieces) of the natural object data Ta at the data receiver 1A in Modification Example C. In this case, the data receiver 1A may be configured to output the plurality of pieces (N-pieces) of the natural object data Ta and the one piece of the artificial object data Tb thus received to the data converter 1G. In the present modification example, the data converter 1G may be configured to, upon receiving the plurality of pieces (N-pieces) of the natural object data Ta and the one piece of the artificial object data Tb, convert the plurality of pieces (N-pieces) of the natural object data Ta and the one piece of the artificial object data Tb into a plurality of pieces (N-pieces) of the natural object data Ia and one piece of the artificial object data Ib, respectively, using the conversion data 1H.

As described above, the present modification example may be different from Modification Example C in that the plurality of pieces (N-pieces) of the natural object data Ta is received by the data receiver 1A. However, as in Modification Example C, it is possible to effectively create a further novel design and present the user with a design effective in creating ideas.

### 4. Application Example

Next, a description is given of an application example of the synthetic data generation system 1 according to the first example embodiment and Modification Examples A to D.

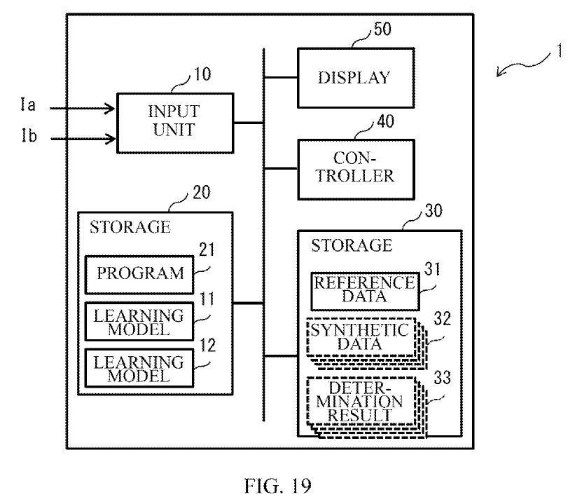

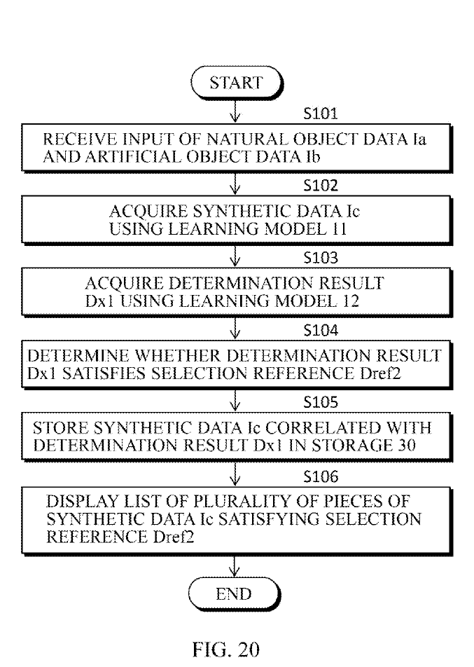

FIG. 19 illustrates an exemplary internal configuration of a single information processing apparatus to which the synthetic data generation system 1 according to the first example embodiment is applied. As illustrated in FIG. 19, for example, the synthetic data generation system 1 according to the present application example may include an input unit 10, a storage 20, a storage 30, a controller 40, and a display 50.

The input unit 10 may be configured to implement an operation similar to that of the data receiver 1A. The input unit 10 may include an interface configured to receive input of the natural object data Ia and the artificial object data Ib. The natural object data Ia and the artificial object data Ib sharing a common data format with each other may be input to the input unit 10. The input unit 10 may be configured to output the natural object data Ia and the artificial object data Ib thus received to the controller 40.

The storage 20 may be a non-transitory tangible recording medium. The storage 20 may include, for example, a non-volatile memory, such as an electrically erasable programmable read-only memory (EEPROM), a flash memory, or a resistive random-access memory. As illustrated in FIG. 19, for example, the storage 20 may hold a program 21 and the learning models 11 and 12. The program 21 may be a program configured to cause the controller 40 to implement a series of processes of a list display procedure to be performed by the synthetic data generation system 1 according to the present application example. In one embodiment, the program 21 may serve as a "synthetic data generation program".

The storage 30 may include, for example, a non-volatile memory, such as an EEPROM, a flash memory, or a resistive random-access memory. As illustrated in FIG. 19, for example, the storage 30 may hold reference data 31. The reference data 31 may include the determination reference Dref1 and the selection reference Dref2. The storage 30 may further hold synthetic data 32 and a determination result 33. The synthetic data 32 may include the synthetic data Ic generated by the controller 40. Every time the controller 40 generates the synthetic data Ic, the generated synthetic data Ic may be added to the synthetic data 32. The determination result 33 may include the determination result Dx1. Every time the controller 40 generates the determination result Dx1, the generated determination result Dx1 may be added to the determination result 33. In the synthetic data 32 and the determination result 33, the synthetic data Ic and the determination result Dx1 may be correlated with each other.

The controller 40 may be configured to implement the series of processes of the list display procedure to be performed by the synthetic data generation system 1 according to the present application example when the program 21 is loaded in the controller 40. The controller 40 may be configured to implement an operation similar to that of the generative AI unit 1B, using the learning model 11. The controller 40 may be configured to implement an operation similar to that of the filter unit 1C, using the learning model 12 and the reference data 31.

The controller 40 may be configured to, upon receiving the natural object data Ia and the artificial object data Ib, send the natural object data Ia and the artificial object data Ib thus received to the learning model 11. The controller 40 may be configured to receive the synthetic data Ic from the learning model 11 in response to the input of the natural object data Ia and the artificial object data Ib to the learning model 11.

The controller 40 may be configured to perform the filtering based on the reference data 1D on the synthetic data Ic acquired from the learning model 11. The controller 40 may be configured to, if the synthetic data Ic is determined to satisfy the requirement indicated by the reference data 1D as a result of the filtering, correlate the synthetic data Ic with the result of the filtering (the determination result Dx1) and store the synthetic data Ic in the synthetic data 32 and the determination result 33 in the storage 30. The controller 40 may be configured to send the synthetic data Ic and the determination reference Dref1 to the learning model 12. The controller 40 may be configured to acquire the determination result Dx1 from the learning model 12 in response to the input of the synthetic data Ic and the determination reference Dref1 to the learning model 12.

The controller 40 may be configured to determine whether the determination result Dx1 received from the learning model 12 satisfies the selection reference Dref2. The controller 40 may be configured to, if the determination result Dx1 is determined to satisfy the selection reference Dref2, correlate the synthetic data Ic with the determination result Dx1 and store the synthetic data Ic in the synthetic data 32 and the determination result 33 in the storage 30. The controller 40 may be configured to perform the filtering based on the reference data 1D and determine whether the determination result Dx1 satisfies the selection reference Dref2, every time the synthetic data Ic is acquired. In this way, the controller 40 may be configured to store a plurality of pieces of the synthetic data Ic satisfying the selection reference Dref2 in the storage 30.

The controller 40 may be configured to output the plurality of pieces of the synthetic data Ic satisfying the selection reference Dref2 and stored in the storage 30, as the synthetic data list IcL, to the display 50. In some embodiments, the controller 40 may be configured to generate thumbnail data of each piece of the synthetic data Ic satisfying the selection reference Dref2 and read from the storage 30, and output the synthetic data list IcL including the plurality of pieces of the thumbnail data thus generated to the display 50. In this way, the controller 40 may be configured to perform the data processing to cause the plurality of pieces of the synthetic data Ic satisfying the selection reference Dref2 to be displayed in a list form.

The controller 40 may be configured to output the synthetic data list IcL to the display 50 at a predetermined timing. In some embodiments, the controller 40 may be configured to output the synthetic data list IcL to the display 50 when a request is received from the user of the synthetic data generation system 1 or every time the synthetic data Ic satisfying the selection reference Dref2 is stored in the storage 30.

The display 50 may be configured to display a list of the plurality of pieces of the synthetic data Ic (the synthetic data list IcL) generated by the controller 40. The display 50 may be configured to generate the interface IF1 upon receiving the synthetic data list IcL. The display 50 may include, for example, a liquid crystal panel or an organic EL panel. In some embodiments, the display 50 may be configured to cause the interface IF1 to display the synthetic data Ic selected by the user in an enlarged manner. In some embodiments, the display 50 may be configured to cause the interface IF1 to generate a selection flag corresponding to the synthetic data Ic selected by the user, and output the selection flag thus generated to the controller 40. At this time, the controller 40 may be configured to correlate the selection flag with the synthetic data selected by the user from the plurality of pieces of the synthetic data Ic included in the storage 1E, and store the selection flag in the storage 30.

The display 50 may be configured to generate the interface IF2. When the score threshold of the first selection reference ("Car Wheel") or the score threshold of the second selection reference ("Not Car Wheel") is adjusted, the display 50 may be configured to output the adjusted threshold to the controller 40. The controller 40 may be configured to store the adjusted threshold in the reference data 31 in the storage 30.

Next, a description is given of the list display procedure to be performed by the synthetic data generation system 1 according to the present application example. FIG. 20 illustrates an example of the list display procedure to be performed by the synthetic data generation system 1 according to the present application example.

First, the controller 40 may receive input of the natural object data Ia and the artificial object data Ib (Step S101). The controller 40 may send the natural object data Ia and the artificial object data Ib thus received to the learning model 11. The controller 40 may acquire the synthetic data Ic, using the learning model 11 (Step S102). The controller 40 may send the synthetic data Ic and the determination reference Dref1 to the learning model 12. The controller 40 may acquire the determination result Dx1, using the learning model 12 (Step S103).

The controller 40 may determine whether the determination result Dx1 satisfies the selection reference Dref2 (Step S104). If the determination result Dx1 satisfies the selection reference Dref2, the controller 40 may correlate the synthetic data Ic with the determination result Dx1 and store the synthetic data Ic in the storage 30 (Step S105). The controller 40 may acquire the determination result Dx1 using the learning model 12, every time the synthetic data Ic is acquired, and if the determination result Dx1 satisfies the selection reference Dref2, correlate the synthetic data Ic with the determination result Dx1 and store the synthetic data Ic in the storage 30. In this way, the controller 40 may store a plurality of pieces of the synthetic data Ic satisfying the selection reference Dref2 in the storage 30.

The controller 40 may output the plurality of pieces of the synthetic data Ic satisfying the selection reference Dref2 and stored in the storage 30, as the synthetic data list IcL, to the display 50. The display 50 may generate the interface IF1 including an image of a list of the plurality of pieces of the synthetic data Ic included in the synthetic data list IcL. In this way, the display 50 may display the list of the plurality of pieces of the synthetic data Ic satisfying the selection reference Dref2 (Step S106). The list display procedure may be performed by the synthetic data generation system 1 according to the present application example as described above.

In the application example, the synthetic data generation system 1 according to the first example embodiment may be achieved by a single information processing apparatus. This allows the user to acquire a design (the synthetic data Ic) effective in creating ideas by inputting the natural object data Ia and the artificial object data Ib to the single information processing apparatus.

Alternatively, in the present application example, the single information processing apparatus may be configured to receive a plurality of pieces (N-pieces) of the natural object data Ia and one piece of the artificial object data Ib. This allows the user to acquire a further novel design (synthetic data Ic) effective in creating ideas by inputting a plurality of pieces (N-pieces) of the natural object data Ia and one piece of the artificial object data Ib to the single information processing apparatus.

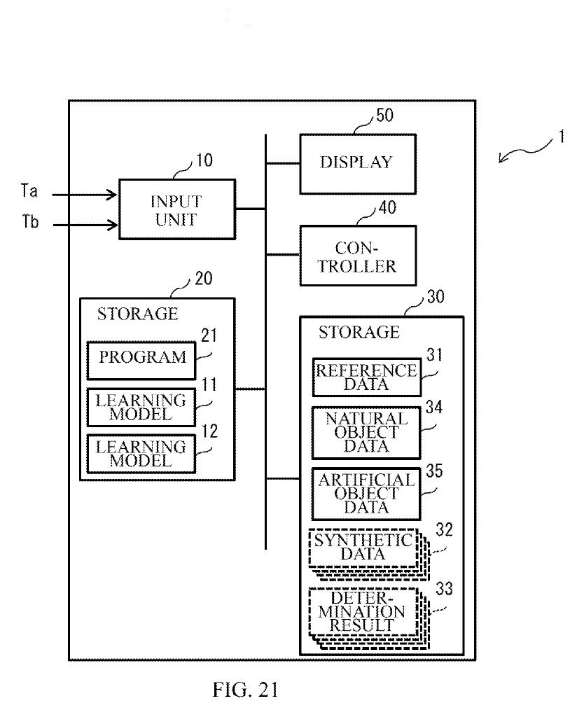

In the present application example, the single information processing apparatus may be configured to receive input of the natural object data Ta and the artificial object data Tb, as illustrated in FIG. 21, for example. In this case, the storage 30 may further hold natural object data 34 and artificial object data 35. In the natural object data 34, the natural object data Ia correlated with the natural object data Ta may be stored. In the artificial object data 35, the artificial object data Ib correlated with the artificial object data Tb may be stored.

The input unit 10 may include an interface configured to receive input of the natural object data Ta and the artificial object data Tb. The natural object data Ta and the artificial object data Tb sharing a common data format with each other may be input to the input unit 10. The input unit 10 may be configured to send the natural object data Ta and the artificial object data Tb thus received to the controller 40.

The controller 40 may be configured to, upon receiving the natural object data Ta and the artificial object data Tb, extract the natural object data Ia corresponding to the natural object data Ta and the artificial object data Ib corresponding to the artificial object data Tb from the natural object data 34 and the artificial object data 35 in the storage 30. The controller 40 may be configured to send the natural object data Ia and the artificial object data Ib extracted from the storage 30 to the learning model 11.

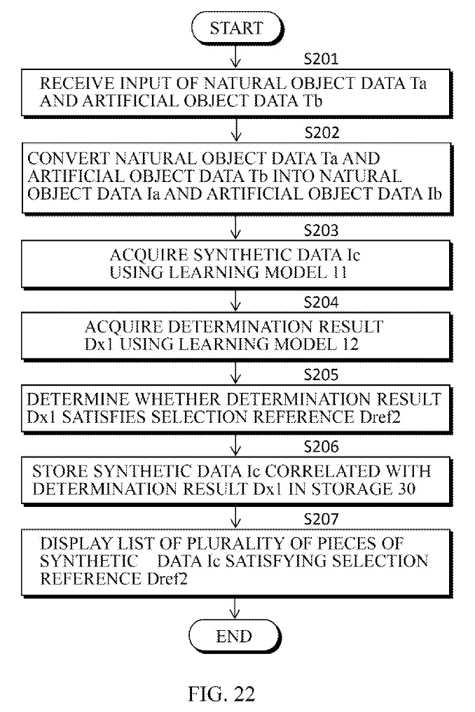

Next, a description is given of a modification example of the list display procedure to be performed by the synthetic data generation system 1 according to the present application example. FIG. 22 illustrates the modification example of the list display procedure to be performed by the synthetic data generation system 1 according to the present application example.

First, the controller 40 may receive input of the natural object data Ta and the artificial object data Tb (Step S201). The controller 40 may convert the natural object data Ta and the artificial object data Tb thus received into the natural object data Ia and the artificial object data Ib, respectively, using the natural object data 34 and the artificial object data 35 in the storage 30 (Step S202). The controller 40 may send the natural object data Ia and the artificial object data Ib obtained as a result of the conversion to the learning model 11. The controller 40 may acquire the synthetic data Ic, using the learning model 11 (Step S203). The controller 40 may send the synthetic data Ic and the determination reference Dref1 to the learning model 12. The controller 40 may acquire the determination result Dx1, using the learning model 12 (Step S204).

The controller 40 may determine whether the determination result Dx1 satisfies the selection reference Dref2 (Step S205). If the determination result Dx1 satisfies the selection reference Dref2, the controller 40 may correlate the synthetic data Ic with the determination result Dx1 and store the synthetic data Ic in the storage 30 (Step S206). The controller 40 may acquire the determination result Dx1 using the learning model 12, every time the synthetic data Ic is acquired, and if the determination result Dx1 satisfies the selection reference Dref2, correlate the synthetic data Ic with the determination result Dx1 and store the synthetic data Ic in the storage 30. In this way, the controller 40 may store a plurality of pieces of the synthetic data Ic satisfying the selection reference Dref2 in the storage 30.

The controller 40 may output the plurality of pieces of the synthetic data Ic satisfying the selection reference Dref2 and stored in the storage 30, as the synthetic data list IcL, to the display 50. The display 50 may generate the interface IF1 including an image of a list of the plurality of pieces of the synthetic data Ic included in the synthetic data list IcL. In this way, the display 50 may display the list of the plurality of pieces of the synthetic data Ic satisfying the selection reference Dref2 (Step S207). The list display procedure may be performed by the synthetic data generation system 1 according to the present application example as described above.

In the present application example, the synthetic data generation system 1 according to the first example embodiment may be achieved by a single information processing apparatus. This allows the user to acquire a design (the synthetic data Ic) effective in creating ideas by inputting the natural object data Ia and the artificial object data Ib to the single information processing apparatus.

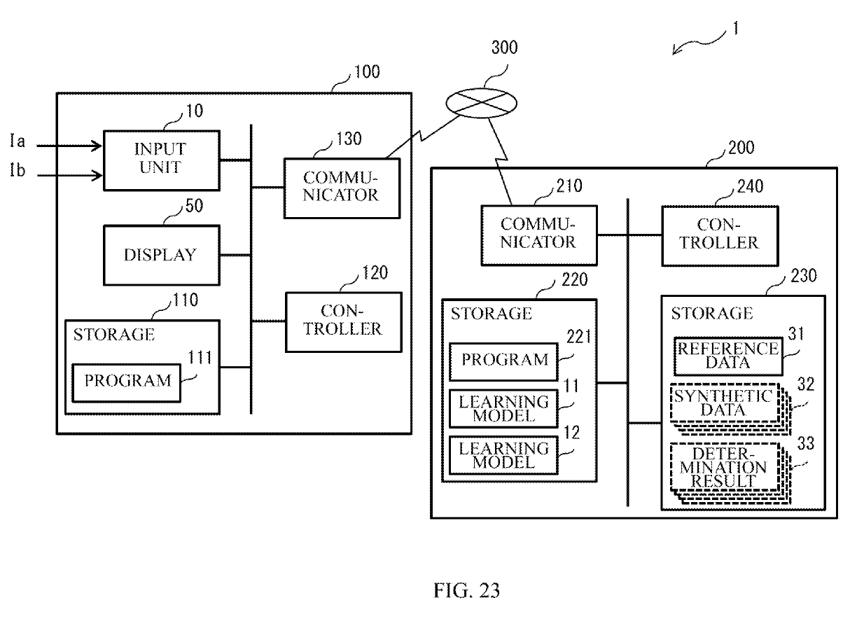

Alternatively, in the present application example, the synthetic data generation system 1 illustrated in FIG. 19 may be achieved by a terminal device 100 and a server apparatus 200 coupled via a communication network 300, as illustrated in FIG. 23, for example. The communication network 300 may be, for example, a wired local area network (LAN) such as Ethernet, a wireless LAN such as Wi-Fi, or a mobile-phone line.

The terminal device 100 may include, for example, the input unit 10, the display 50, a storage 110, a controller 120, and a communicator 130. The communicator 130 may include an interface configured to communicate with the server apparatus 200 via the communication network 300. The storage 110 may be a non-transitory tangible recording medium. The storage 110 may include, for example, a non-volatile memory, such as an EEPROM, a flash memory, or a resistive random-access memory. The storage 110 may hold a program 111. The program 111 may include a series of processes to transmit the natural object data Ia and the artificial object data Ib received at the input unit 10 to the server apparatus 200 and to perform the data processing that causes the plurality of pieces of the synthetic data Ic satisfying selection reference Dref2 and included in the synthetic data list IcL received from the server apparatus 200 to be displayed in a list form.

The controller 120 may be configured to transmit the natural object data Ia and the artificial object data Ib received at the input unit 10 to the server apparatus 200 when the program 111 is loaded in the controller 120. The controller 120 may be configured to perform the series of processes to cause the plurality of pieces of the synthetic data Ic satisfying the selection reference Dref2 and included in the synthetic data list IcL received from the server apparatus 200 to be displayed on the display 50 in a list form when the program 111 is loaded in the controller 120. The display 50 may be configured to display the plurality of pieces of the synthetic data Ic included in the synthetic data list IcL in a list form.

The server apparatus 200 may include, for example, a communicator 210, storages 220 and 230, and a controller 240. The communicator 210 may include an interface configured to communicate with the terminal device 100 via the communication network 300. The storages 220 and 230 may be non-transitory tangible recording media. The storages 220 and 230 may be, for example, non-volatile memories, such as EEPROMs, flash memories, or resistive random-access memories.

The storage 220 may hold a program 221 and the learning models 11 and 12. The program 221 may include a series of processes to receive the natural object data Ia and the artificial object data Ib from the terminal device 100 and to generate the synthetic data list IcL using the natural object data Ia and the artificial object data Ib received from the terminal device 100. The storage 230 may hold the reference data 31. The storage 230 may further hold the synthetic data 32 and the determination result 33.

The controller 240 may be configured to perform the series of processes to receive the natural object data Ia and the artificial object data Ib from the terminal device 100 and to generate the synthetic data list IcL using the natural object data Ia and the artificial object data Ib received from the terminal device 100 when the program 221 is loaded in the controller 240.

In a case where the synthetic data generation system 1 illustrated in FIG. 19 is achieved by the terminal device 100 and the server apparatus 200 coupled via the communication network 300 as described above, a relatively low-spec terminal device may be used as the terminal device 100. Further, the server apparatus 200 may be shared by a plurality of terminal devices 100, which allows additional terminal devices 100 to be added at a low cost.

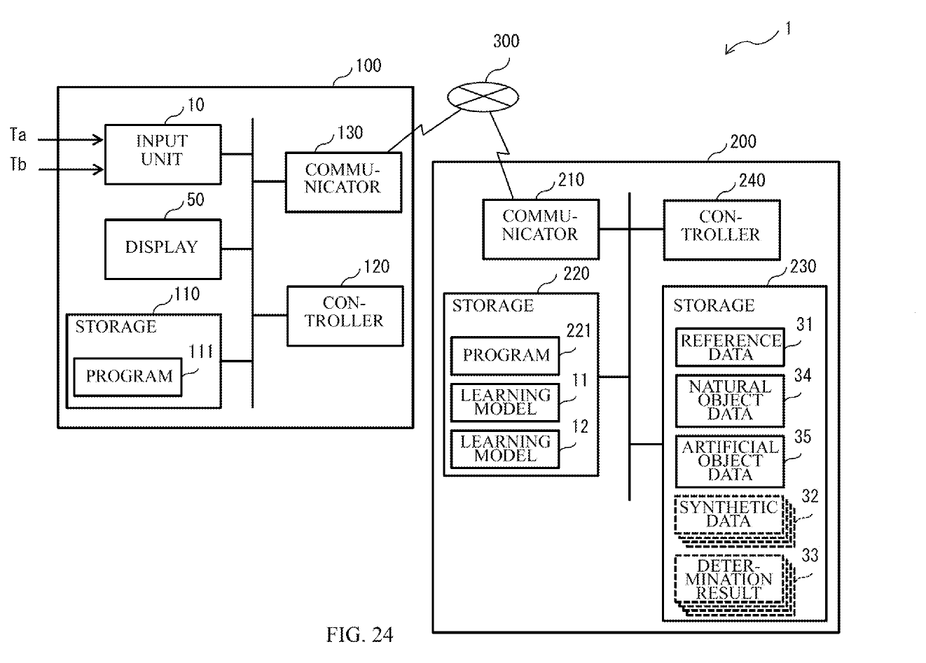

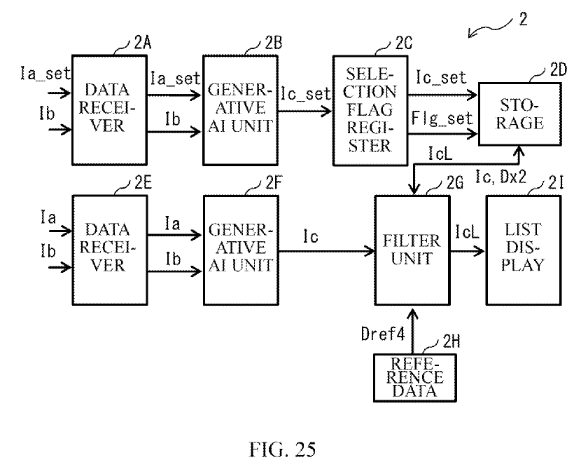

Alternatively, in the present application example, the synthetic data generation system 1 illustrated in FIG. 21 may be achieved by the terminal device 100 and the server apparatus 200 coupled via the communication network 300, as illustrated in FIG. 24, for example. The storage 230 in the server apparatus 200 may hold the reference data 31, the natural object data 34, and the artificial object data 35. The storage 230 may further hold the synthetic data 32 and the determination result 33.

In a case where the synthetic data generation system 1 illustrated in FIG. 21 is achieved by the terminal device 100 and the server apparatus 200 coupled via the communication network 300 as described above, a relatively low-spec terminal device may be used as the terminal device 100. Further, the server apparatus 200 may be shared by a plurality of terminal devices 100, which allows additional terminal devices 100 to be added at a low cost.

### 5. Second Example Embodiment

### Configuration Example

Next, a description is given of a synthetic data generation system 2 according to a second example embodiment of the disclosure. FIG. 25 is a block diagram illustrating an exemplary operation of the synthetic data generation system 2. As illustrated in FIG. 25, for example, the synthetic data generation system 2 may include a data receiver 2A, a generative AI unit 2B, a selection flag register 2C, a storage 2D, a data receiver 2E, a generative AI unit 2F, a filter unit 2G, reference data 2H, and a list display 2I.

In one embodiment, the synthetic data generation system 2 may serve as the "synthetic data generation system". In one embodiment, the generative AI unit 2B may serve as the "first learning model". In one embodiment, the selection flag register 2C may serve as the "processor". In one embodiment, the filter unit 2G may serve as the "second learning model" and the "processor".

The data receiver 2A may include an interface configured to receive input of natural object data set Ia_set and the artificial object data Ib. The natural object data set Ia_set may include a plurality of pieces of the natural object data Ia. The plurality of pieces of the natural object data Ia included in the natural object data set Ia_set may include, for example, natural objects whose natural object data Ia are different from one another in one or more of individual, angle, and scale. In some embodiments, the plurality of pieces of the natural object data Ia included in the natural object data set Ia_set may include, for example, natural objects whose natural object data Ia are the same in all of individual, angle, and scale. The natural object data Ia and the artificial object data Ib sharing a common data format with each other may be input to the data receiver 2A. The data receiver 2A may be configured to send the natural object data set Ia_set and the artificial object data Ib thus received to the generative AI unit 2B.

The generative AI unit 2B may be configured to, upon receiving the natural object data set Ia_set and the artificial object data Ib, sequentially send the plurality of pieces of the natural object data Ia included in the natural object data set Ia_set thus received, one by one, to the learning model 11, and send the artificial object data Ib to the learning model 11 in accordance with the input of the natural object data Ia to the learning model 11. The learning model 11 may be configured to, upon receiving the natural object data Ia and the artificial object data Ib, generate and output the synthetic data Ic by combining the natural object data Ia and the artificial object data Ib thus received with each other. The learning model 11 may be configured to generate and output the synthetic data Ic, every time the natural object data Ia and the artificial object data Ib are received.

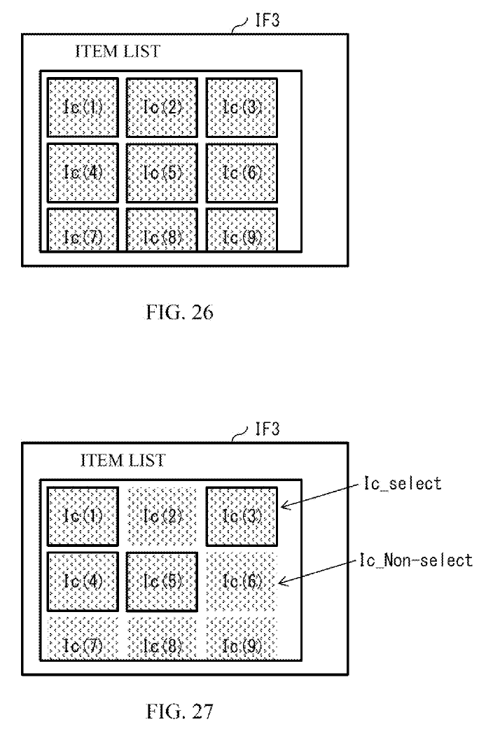

As illustrated in FIG. 26, for example, the selection flag register 2C may be configured to generate an interface IF3 including an image of a list of the plurality of pieces of the synthetic data Ic obtained by the generative AI unit 2B. The interface IF3 may be configured to display the synthetic data Ic designated by the user in an enlarged manner, for example. As illustrated in FIG. 27, for example, the interface IF3 may be configured to display the synthetic data Ic selected by the user (synthetic data Ic_select) and the synthetic data Ic not selected by the user (synthetic data Ic_Non-select) in a distinguishable manner.

The interface IF3 may be configured to generate a selection flag for the synthetic data Ic_select, and a non-selection flag for the synthetic data Ic_Non-select. The interface IF3 may be configured to store a flag data set Flg_set including one or more selection flags and one or more non-selection flags thus generated, in the storage 2D, together with the plurality of pieces of the synthetic data Ic obtained by the generative AI unit 2B.

The interface IF3 may be configured to store the one or more pieces of the synthetic data Ic_Non-select as a determination reference Dref3 in the reference data 2H. In some embodiments, the interface IF3 may be configured to store a feature amount of the one or more pieces of the synthetic data Ic_Non-select as the determination reference Dref3 in the reference data 2H. In one embodiment, the determination reference Dref3 may serve as the "determination reference".

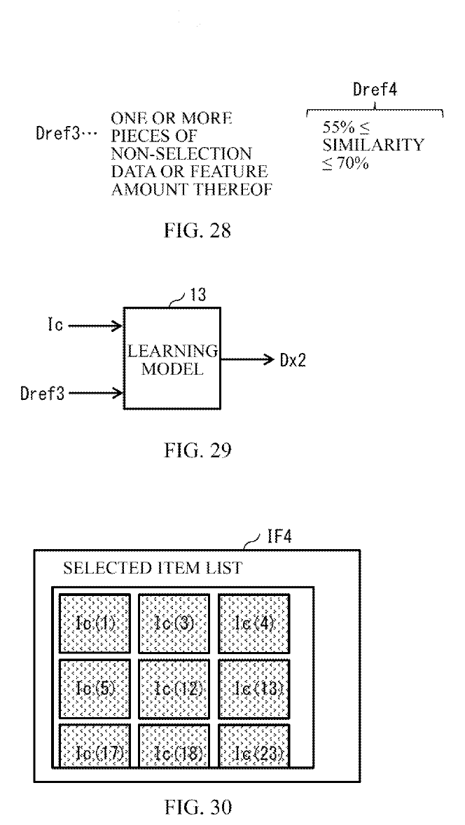

The reference data 2H may be a data set to be used in the filter unit 2G. As illustrated in FIG. 28, for example, the reference data 2H may include the determination reference Dref3 and a selection reference Dref4. In one embodiment, the determination reference Dref3 may serve as the "determination reference". In one embodiment, the selection reference Dref4 may serve as the "selection reference". The determination reference Dref3 may include a feature amount of the one or more pieces of the synthetic data Ic_Non-select, or a feature amount of one or more pieces of the synthetic data Ic_Non-select. The selection reference Dref4 may include a threshold (e.g., 55% or greater and 70% or less) for similarity generated by the filter unit 2G described below.

The data receiver 2E may include an interface configured to receive input of the natural object data Ia and the artificial object data Ib. The natural object data Ia and the artificial object data Ib sharing a common data format with each other may be input to the data receiver 2E. The data receiver 2E may be configured to output the natural object data Ia and the artificial object data Ib thus received to the generative AI unit 2F. The generative AI unit 2F may include the learning model 11. The learning model 11 may be configured to, upon receiving the natural object data Ia and the artificial object data Ib, generate and output the synthetic data Ic by combining the natural object data Ia and the artificial object data Ib thus received with each other. The generative AI unit 2F may be configured to generate and output the synthetic data Ic generated by the learning model 11 to the filter unit 2G.

The filter unit 2G may include a learning model 13. The learning model 13 may be configured to, upon receiving the synthetic data Ic generated by the generative AI unit 2F and one or more pieces of the synthetic data Ic_Non-select (the determination reference Dref3), generate and output a determination result Dx2 regarding the received synthetic data Ic determined based on the received determination reference Dref3. In one embodiment, the learning model 13 may serve as the "second learning model". The determination result Dx2 may be data representing similarity (first similarity) of the synthetic data Ic generated by the generative AI unit 2F with the one or more pieces of the synthetic data Ic_Non-select (the determination reference Dref3). The determination result Dx2 may be data representing similarity (second similarity) of the feature amount of the synthetic data Ic generated by the generative AI unit 2F with the feature amount of the one or more pieces of the synthetic data Ic_Non-select (the determination reference Dref3).

The filter unit 2G may be configured to determine whether the determination result Dx2 obtained by the learning model 13 satisfies the selection reference Dref4. The filter unit 2G may be configured to, if the determination result Dx2 satisfies the selection reference Dref4, correlate the synthetic data Ic with the determination result Dx2 and store the synthetic data Ic in the storage 2D. The filter unit 2G may be configured to perform the filtering based on the reference data 2H and determine whether the determination result Dx2 satisfies the selection reference Dref4, every time the synthetic data Ic is received. In this way, the filter unit 2G may be configured to store the synthetic data Ic satisfying the selection reference Dref4 in the storage 2D.

The filter unit 2G may be configured to output the plurality of pieces of the synthetic data Ic satisfying the selection reference Dref4 and stored in the storage 2D, as the synthetic data list IcL, to the list display 2I. In some embodiments, the filter unit 2G may be configured to generate thumbnail data of each piece of the synthetic data Ic satisfying the selection reference Dref4 and read from the storage 2D, and output the synthetic data list IcL including a plurality of pieces of the thumbnail data thus generated to the list display 2I. In this way, the filter unit 2G may be configured to perform the data processing to cause the plurality of pieces of the synthetic data Ic satisfying the selection reference Dref4 to be displayed in a list form.

The filter unit 2G may be configured to output the synthetic data list IcL to the list display 2I at a predetermined timing. In some embodiments, the filter unit 2G may be configured to output the synthetic data list IcL to the list display 2I when a request is received from a user of the synthetic data generation system 2 or every time the synthetic data Ic satisfying the selection reference Dref4 is stored in the storage 2D.

As illustrated in FIG. 30, for example, the list display 2I may be configured to, upon receiving the synthetic data list IcL, generate an interface IF4 including an image of a list of the plurality of pieces of the synthetic data Ic included in the synthetic data list IcL. In some embodiments, the interface IF4 may be configured to display the synthetic data Ic designated by the user in an enlarged manner.

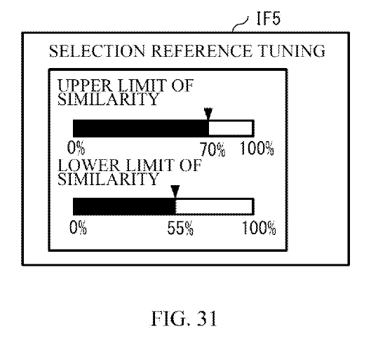

As illustrated in FIG. 31, for example, the filter unit 2G in the synthetic data generation system 2 may be configured to generate an interface IF5 with which a threshold of the first similarity or a threshold of the second similarity is adjustable. In this case, the interface IF5 may be configured to adjust an upper limit of the threshold of the first similarity or the threshold of the second similarity, and a lower limit of the threshold of the first similarity or the threshold of the second similarity, in response to user input, for example. The filter unit 2G may be configured to, when the upper limit of the threshold of the first similarity or the threshold of the second similarity or the lower limit of the threshold of the first similarity or the threshold of the second similarity is adjusted, update the reference data 2H with the adjusted threshold.

### Effects

Next, a description is given of effects of the synthetic data generation system 2.

According to the present example embodiment, upon receiving the natural object data Ia and the artificial object data Ib1, the learning model 11 outputs the synthetic data Ic by combining the natural object data Ia and the artificial object data Ib1 thus received with each other. Upon receiving the synthetic data Ic and the determination reference Dref3, the learning model 13 outputs the determination result Dx2 regarding the synthetic data Ic determined based on the determination reference Dref3. Thereafter, the filter unit 2G determines whether the determination result Dx2 satisfies the selection reference Dref4, and performs the data processing to cause the plurality of pieces of the synthetic data Ic satisfying the selection reference Dref4 to be displayed in a list form. This makes it possible to exclude an infeasible design quite different from the artificial object (item) that the user wants to design or a passable design without novelty in advance before the list is displayed. As a result, it is possible to present the user with a design effective in creating ideas.

In the present example embodiment, the synthetic data Ic correlated with the determination result Dx2 may be held in the storage 2D. This makes it possible to cause the synthetic data Ic newly acquired to be displayed in a list form together with the plurality of pieces of the synthetic data Ic determined to satisfy the selection reference Dref4 in the past determination result Dx2. As a result, it is possible to present the user with a plurality of designs (synthetic data Ic) effective in creating ideas.

In the present example embodiment, one or more pieces of the synthetic data Ic_Non-select or their feature amounts may be stored as the determination reference Dref3 in the reference data 2H. This makes it possible to exclude an infeasible design quite different from the artificial object (item) that the user wants to design or a passable design without novelty in advance before the list is displayed. As a result, it is possible to present the user with a design effective in creating ideas.

In the present example embodiment, the determination result Dx2 may be the data representing the first similarity or the second similarity described above, and the selection reference Dref4 may include the threshold of the first similarity or the threshold of the second similarity described above. This makes it possible to exclude an infeasible design quite different from the artificial object (item) that the user wants to design or a passable design without novelty in advance before the list is displayed. As a result, it is possible to present the user with a design effective in creating ideas.

### 6. Modification Examples of Second Example Embodiment

Next, a description is given of modification examples of the synthetic data generation system 2.

### Modification Example E

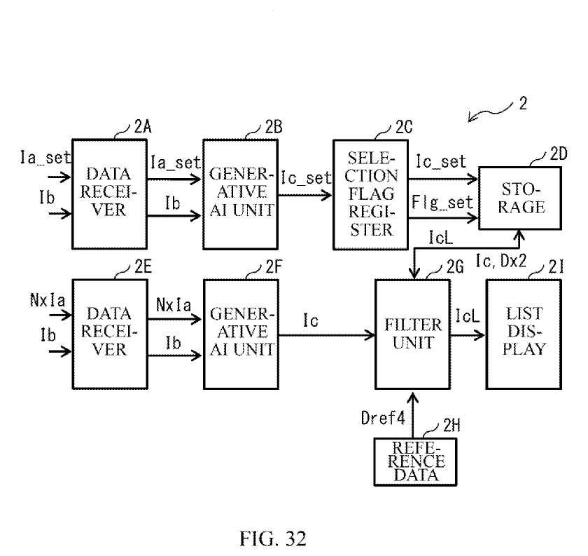

FIG. 32 is a block diagram illustrating a modification example of the operation of the synthetic data generation system 2. As illustrated in FIG. 32, for example, the synthetic data generation system 2 may be configured to receive a plurality of pieces (N-pieces) of the natural object data Ia at the data receiver 2E. The plurality of pieces (N-pieces) of the natural object data Ia may include natural objects different from one another. When two pieces of the natural object data Ia are received by the data receiver 2E, the natural object included in one of the two pieces of the natural object data Ia received by the data receiver 2E may be, for example, a dog, and the natural object included in the other piece of the natural object data Ia may include, for example, a cat.

In the present modification example, the data receiver 2E may include an interface configured to receive input of a plurality of pieces (N-pieces) of the natural object data Ia and one piece of the artificial object data Ib. The data receiver 2E may be configured to send the plurality of pieces (N-pieces) of the natural object data Ia and the one piece of the artificial object data Ib thus received to the generative AI unit 2F. The learning model 11 in the generative AI unit 2F may be configured to, upon receiving the plurality of pieces (N-pieces) of the natural object data Ia and the one piece of the artificial object data Ib, generate and output the synthetic data Ic by combining the plurality of pieces (N-pieces) of the natural object data Ia and the one piece of the artificial object data Ib with each other. In the present modification example, the learning model 11 may be a model trained based on teaching data including, for example, a plurality of pieces (N-pieces) of the natural object data Ia_test, one piece of the artificial object data Ib_test, and one piece of the synthetic data Ic_test.

The product included in the synthetic data Ic may be a combination of the natural objects included in the plurality of pieces (N-pieces) of the natural object data Ia and the artificial object included in the artificial object data Ib. When two pieces of the natural object data Ia are received by the generative AI unit 2F, one of the two pieces of the natural object data Ia received by the generative AI unit 2F may include, for example, a dog, and the other piece of the natural object data Ia may include, for example, a cat. Further, the artificial object data Ib may include a vehicle wheel. In this case, the product included in the synthetic data Ic may be a combination of the dog, the cat, and the vehicle wheel.

In the present modification example, the plurality of pieces (N-pieces) of the natural object data Ia and the one piece of the artificial object data Ib may be received by the generative AI unit 2F. It is therefore possible to effectively create a further novel design and present the user with a design effective in creating ideas.

### Modification Example F

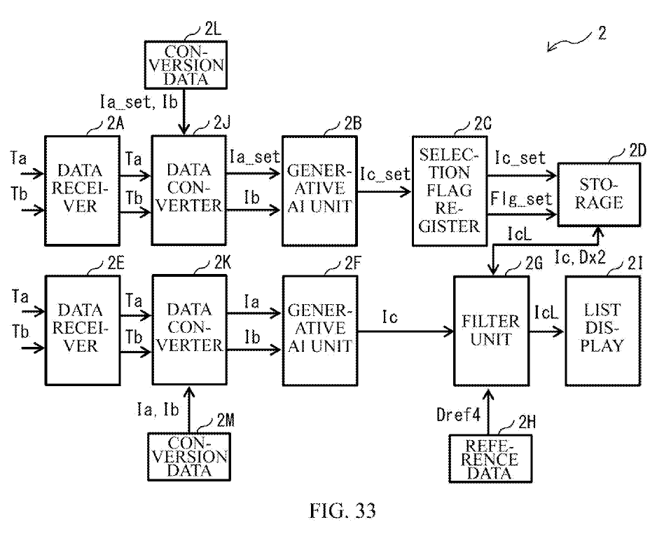

FIG. 33 is a block diagram illustrating a modification example of the operation of the synthetic data generation system 2. As illustrated in FIG. 33, for example, the synthetic data generation system 2 may include an interface allowing the natural object data Ta and the artificial object data Tb to be received at the data receivers 2A and 2E. The natural object data Ta and the artificial object data Tb having data formats common to each other may be input to the data receivers 2A and 2E. The data receiver 2A may be configured to send the natural object data Ta and the artificial object data Tb thus received to a data converter 2J. The data receiver 2E may be configured to send the natural object data Ta and the artificial object data Tb thus received to a data converter 2K.

In the present modification example, the synthetic data generation system 2 may further include the data converters 2J and 2K, and conversion data 2L and 2M, as illustrated in FIG. 33, for example. The data converter 2J may be configured to, upon receiving the natural object data Ta and the artificial object data Tb, convert the natural object data Ta and the artificial object data Tb into the natural object data set Ia_set and the artificial object data Ib, respectively, using the conversion data 2L. The data converter 2J may be configured to output the natural object data set Ia_set and the artificial object data Ib obtained as a result of the conversion to the generative AI unit 2B.

In the conversion data 2L, the natural object data set Ia_set may be held in correlation with the natural object data Ta, and the artificial object data Ib may be held in correlation with the artificial object data Tb. The data converter 2J may be configured to, upon receiving the natural object data Ta, extract the natural object data set Ia_set corresponding to the natural object data Ta thus received, from the conversion data 2L. The data converter 2J may be configured to, upon receiving the artificial object data Tb, extract the artificial object data Ib corresponding to the artificial object data Tb thus received, from the conversion data 2L.

In the conversion data 2M, the natural object data Ia may be held in correlation with the natural object data Ta, and the artificial object data Ib may be held in correlation with the artificial object data Tb. The data converter 2K may be configured to, upon receiving the natural object data Ta, extract the natural object data Ia corresponding to the natural object data Ta thus received, from the conversion data 2M. The data converter 2K may be configured to, upon receiving the artificial object data Tb, extract the artificial object data Ib corresponding to the artificial object data Tb thus received, from the conversion data 2M.

In the present modification example, the natural object data Ta and the artificial object data Tb received by the data receiver 2A are converted into the natural object data set Ia_set and the artificial object data Ib, respectively, at the data converter 2J. Thereafter, the natural object data Ia and the artificial object data Ib obtained as a result of the conversion may be sent to the generative AI unit 2B. Further, the natural object data Ta and the artificial object data Tb received by the data receiver 2E may be converted into the natural object data Ia and the artificial object data Ib, respectively, at the data converter 2K. Thereafter, the natural object data Ia and the artificial object data Ib obtained as a result of the conversion may be sent to the generative AI unit 2F. This allows the user to acquire the synthetic data Ic by simply inputting text data. As a result, it is possible to reduce the time and effort of the user in inputting data, and to present the user with a design effective in creating ideas.

### 7. Application Example

Next, a description is given of an application example of the synthetic data generation system 2 according to the second example embodiment and Modification Examples E and F.

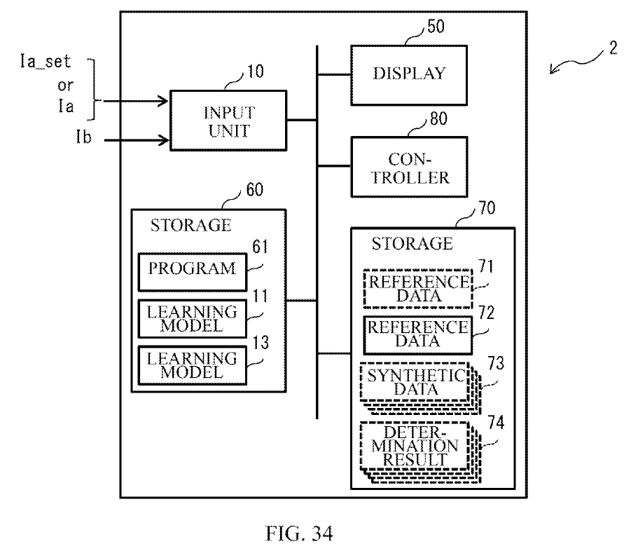

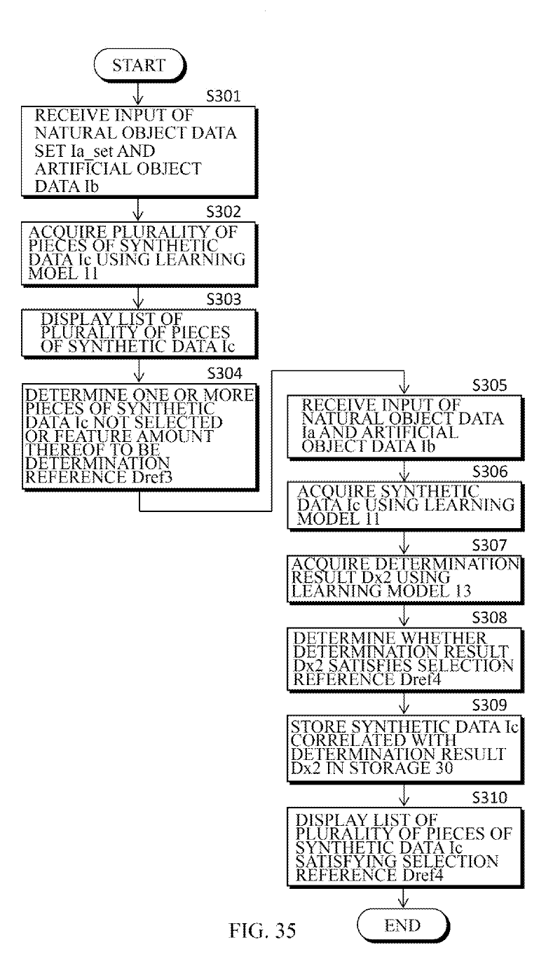

FIG. 34 illustrates an exemplary internal configuration of a single information processing apparatus to which the synthetic data generation system 2 according to the second example embodiment is applied. As illustrated in FIG. 34, for example, the synthetic data generation system 2 according to the present application example may include the input unit 10, a storage 60, a storage 70, a controller 80, and the display 50.

The input unit 10 may be configured to implement an operation similar to those of the data receivers 2A and 2E. The input unit 10 may include an interface configured to receive input of the natural object data set Ia_set or the natural object data Ia, and input of the artificial object data Ib. The input unit 10 may be configured to send the natural object data set Ia_set or the natural object data Ia, and the artificial object data Ib thus received to the controller 80.

The storage 60 may be a non-transitory tangible recording medium. The storage 60 may include, for example, a non-volatile memory, such as an electrically erasable programmable read-only memory (EEPROM), a flash memory, or a resistive random-access memory. As illustrated in FIG. 34, for example, the storage 60 may hold a program 61, the learning models 11 and 13. The program 61 may be a program configured to cause the controller 80 to implement a series of processes of the list display procedure to be performed by the synthetic data generation system 2 according to the present application example. In one embodiment, the program 61 may serve as the "synthetic data generation program".

The storage 70 may include, for example, a non-volatile memory such as an EEPROM, a flash memory, or a resistive random-access memory. As illustrated in FIG. 34, for example, the storage 70 may hold reference data 72. The reference data 72 may include the selection reference Dref4. The storage 70 may further hold reference data 71, synthetic data 73, and a determination result 74. The reference data 71 may include the determination reference Dref3. The synthetic data 73 may include the synthetic data Ic generated by the controller 80. Every time the controller 80 generates the synthetic data Ic, the generated synthetic data Ic may be added to the synthetic data 73. The determination result 74 may include the determination result Dx2. Every time the controller 80 generates the determination result Dx2, the generated determination result Dx2 may be added to the determination result 74. In the synthetic data 73 and the determination result 74, the synthetic data Ic and the determination result Dx2 may be correlated with each other.

The controller 80 may be configured to implement the series of processes of the list display procedure to be performed by the synthetic data generation system 2 according to the present application example when the program 61 is loaded in the controller 80. The controller 80 may be configured to implement an operation similar to those of the generative AI units 2B and 2F, using the learning model 11. The controller 80 may be configured to implement an operation similar to that of the filter unit 2G, using the learning model 13 and the reference data 71 and 72.

The controller 80 may be configured to, upon receiving the natural object data Ia and the artificial object data Ib, sequentially send the plurality of pieces of the natural object data Ia included in the natural object data set Ia_set thus received, one by one, to the learning model 11, and send the artificial object data Ib to the learning model 11 in accordance with the input of the natural object data Ia to the learning model 11. The learning model 11 may be configured to, upon receiving the natural object data Ia and the artificial object data Ib, generate and output the synthetic data Ic by combining the natural object data Ia and the artificial object data Ib thus received with each other. The learning model 11 may be configured to generate and output the synthetic data Ic, every time the natural object data Ia and the artificial object data Ib are received.

The controller 80 may be configured to generate the interface IF3 including an image of a list of the plurality of pieces of the synthetic data Ic obtained by the learning model 11. In some embodiments, the interface IF3 may be configured to display the synthetic data Ic designated by the user in an enlarged manner. In some embodiments, the interface IF3 may be configured to display the synthetic data Ic selected by the user (synthetic data Ic_select) and the synthetic data Ic not selected by the user (synthetic data Ic_Non-select) in a distinguishable manner.

The interface IF3 may be configured to generate a selection flag for the synthetic data Ic_select, and a non-selection flag for the synthetic data Ic_Non-select. The interface IF3 may be configured to store a flag data set Flg_set including one or more selection flags and one or more non-selection flags thus generated, in the storage 70, together with the plurality of pieces of the synthetic data Ic obtained by the learning model 11.

The interface IF3 may be configured to store the one or more pieces of the synthetic data Ic_Non-select as the determination reference Dref3 in the storage 70. In some embodiments, the interface IF3 may be configured to store a feature amount of the one or more pieces of the synthetic data Ic_Non-select as the determination reference Dref3 in the storage 70.

The controller 80 may be configured to, upon receiving the natural object data Ia and the artificial object data Ib, send the natural object data Ia and the artificial object data Ib thus received to the learning model 11. The learning model 11 may be configured to, upon receiving the natural object data Ia and the artificial object data Ib, generate and output the synthetic data Ic by combining the natural object data Ia and the artificial object data Ib thus received with each other. The learning model 11 may be configured to generate and output the synthetic data Ic, every time the natural object data Ia and the artificial object data Ib are received.

The controller 80 may be configured to send the synthetic data Ic and the one or more pieces of the synthetic data Ic_Non-select (the determination reference Dref3) to the learning model 13, and acquire the determination result Dx2 regarding the synthetic data Ic determined based on the determination reference Dref3 from the learning model 13. The determination result Dx2 may be data representing similarity (first similarity) of the synthetic data Ic generated by the generative AI unit 2F with the one or more pieces of the synthetic data Ic_Non-select (the determination reference Dref3). The determination result Dx2 may be data representing similarity (second similarity) of the feature amount of the synthetic data Ic generated by the generative AI unit 2F with the feature amount of the one or more pieces of the synthetic data Ic_Non-select (the determination reference Dref3).

The controller 80 may be configured to determine whether the determination result Dx2 acquired from the learning model 13 satisfies the selection reference Dref4. The controller 80 may be configured to, if the determination result Dx2 is determined to satisfy the selection reference Dref4, correlate the synthetic data Ic with the determination result Dx2 and store the synthetic data Ic in the synthetic data 73 and the determination result 74 in the storage 70. The controller 80 may be configured to perform the filtering based on the reference data 2H and determine whether the determination result Dx2 satisfies the selection reference Dref4, every time the synthetic data Ic is acquired. In this way, the controller 80 may be configured to store a plurality of pieces of the synthetic data Ic satisfying the selection reference Dref4 in the storage 70.

The controller 80 may be configured to output the plurality of pieces of the synthetic data Ic satisfying the selection reference Dref4 and stored in the storage 70, as the synthetic data list IcL, to the display 50. In some embodiments, the controller 80 may be configured to generate thumbnail data of each piece of the synthetic data Ic satisfying the selection reference Dref4 and read from the storage 70, and output the synthetic data list IcL including the plurality of pieces of the thumbnail data thus generated to the display 50. In this way, the controller 80 may be configured to perform the data processing to cause the plurality of pieces of the synthetic data Ic satisfying the selection reference Dref4 to be displayed in a list form.

The controller 80 may be configured to output the synthetic data list IcL to the display 50 at a predetermined timing. In some embodiments, the controller 80 may be configured to output the synthetic data list IcL to the display 50 when a request is received from the user of the synthetic data generation system 2 or every time the synthetic data Ic satisfying the selection reference Dref4 is stored in the storage 70. The display 50 may be configured to display a list of the plurality of pieces of the synthetic data Ic (the synthetic data list IcL) generated by the controller 80. The display 50 may be configured to generate the interface IF1 upon receiving the synthetic data list IcL. The display 50 may include, for example, a liquid crystal panel or an organic EL panel.

Next, a description is given of the list display procedure to be performed by the synthetic data generation system 2 according to the present application example. FIG. 35 illustrates an example of the list display procedure to be performed by the synthetic data generation system 2 according to the present application example.

First, the controller 80 may receive input of the natural object data set Ia_set and the artificial object data Ib (Step S301). The controller 80 may sequentially send the plurality of pieces of the natural object data Ia included in the natural object data set Ia_set thus received, one by one, to the learning model 11, and send the artificial object data Ib to the learning model 11 in accordance with the input of the natural object data Ia to the learning model 11. The controller 80 may acquire a plurality of pieces of the synthetic data Ic, using the learning model 11 (Step S302).

The controller 80 may cause the plurality of pieces of the synthetic data Ic obtained by the learning model 11 to be displayed in a list form (Step S303). The controller 80 may generate the interface IF3 in which the list of the plurality of pieces of the synthetic data Ic is displayed. The interface IF3 may display the synthetic data Ic selected by the user (the synthetic data Ic_select) and the synthetic data Ic not selected by the user (the synthetic data Ic_Non-select) in a distinguishable manner.

The interface IF3 may generate a selection flag for the synthetic data Ic_select, and a non-selection flag for the synthetic data Ic_Non-select. The interface IF3 may store a flag data set Flg_set including one or more selection flags and one or more non-selection flags thus generated in the storage 70, together with the plurality of pieces of the synthetic data Ic obtained by the learning model 11. The interface IF3 may store the one or more pieces of the synthetic data Ic_Non-select as the determination reference Dref3 in the storage 70. The interface IF3 may store a feature amount of the one or more pieces of the synthetic data Ic_Non-select as the determination reference Dref3 in the storage 70 (Step S304).

The controller 80 may receive input of the natural object data Ia and the artificial object data Ib (Step S305). The controller 80 may send the natural object data Ia and the artificial object data Ib thus received to the learning model 11. The controller 80 may acquire the synthetic data Ic using the learning model 11 (Step S306). The controller 80 may send the synthetic data Ic and one or more pieces of the synthetic data Ic_Non-select (the determination reference Dref3) to the learning model 13, and acquire the determination result Dx2 regarding the synthetic data Ic determined based on the determination reference Dref3, from the learning model 13. The controller 80 may acquire the determination result Dx2, using the learning model 13 (Step S307).

The controller 80 may determine whether the determination result Dx2 acquired from the learning model 13 satisfies the selection reference Dref4 (Step S308). If the determination result Dx2 satisfies the selection reference Dref4, the controller 80 may correlate the synthetic data Ic with the determination result Dx2 and store the synthetic data Ic in the storage 70 (Step S309). The controller 80 may perform the filtering based on the reference data 2H and determine whether the determination result Dx2 satisfies the selection reference Dref4, every time the synthetic data Ic is acquired. In this way, the controller 80 may store a plurality of pieces of the synthetic data Ic satisfying the selection reference Dref4 in the storage 70. The controller 80 may output the plurality of pieces of the synthetic data Ic satisfying the selection reference Dref4 and stored in the storage 70, as the synthetic data list IcL, to the display 50 (Step S310). The list display procedure may be performed by the synthetic data generation system 2 according to the present application example as described above.

In the present application example, the synthetic data generation system 2 according to the second example embodiment may be achieved by a single information processing apparatus. This allows the user to acquire a design (the synthetic data Ic) effective in creating ideas by inputting the natural object data set Ia_set or the natural object data Ia and the artificial object data Ib to the single information processing apparatus.

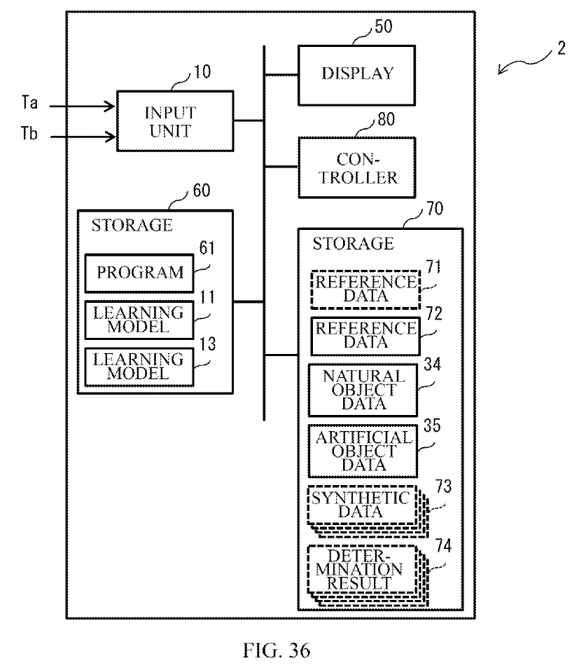

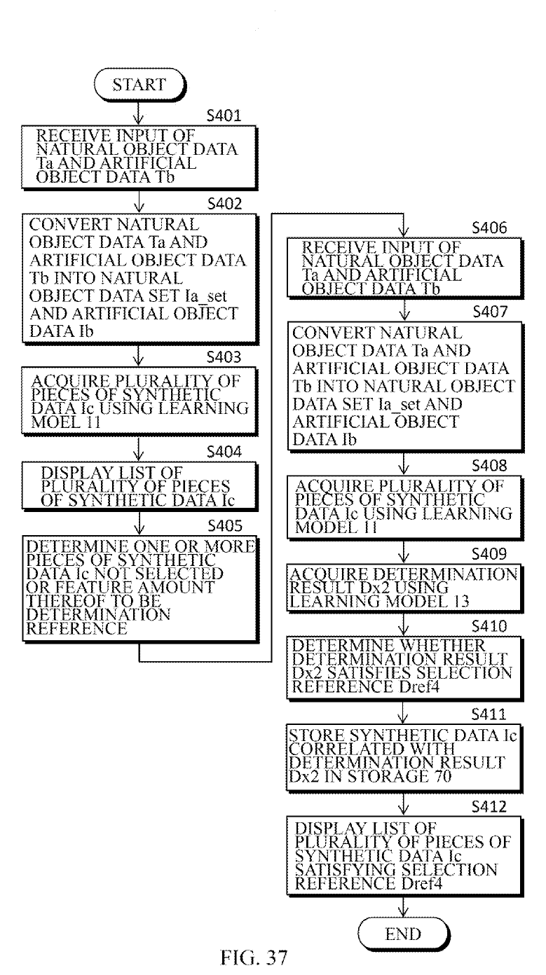

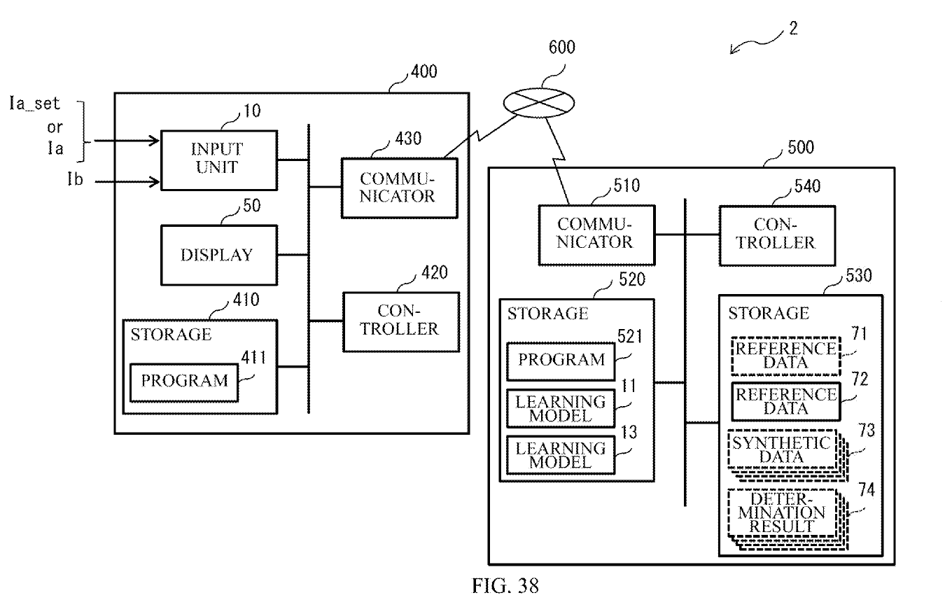

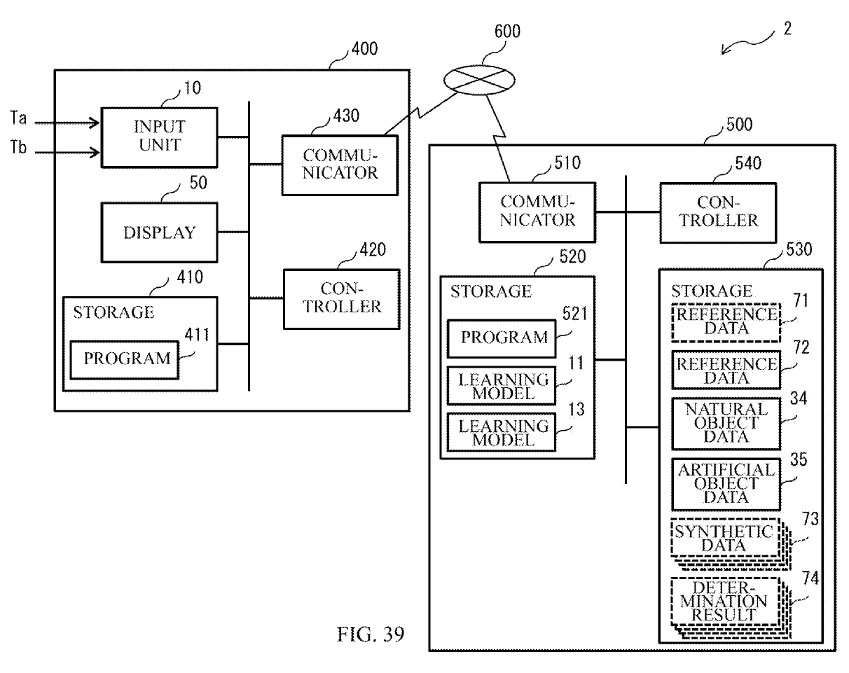

Alternatively, in the present application example, the single information processing apparatus may receive input of the natural object data Ta and the artificial object data Tb, as illustrated in FIG. 36, for example. In this case, the storage 70 may further hold the natural object data 34 and the artificial object data 35.

The input unit 10 may have an interface configured to receive input of the natural object data Ta and the artificial object data Tb. The natural object data Ta and the artificial object data Tb sharing a common data format with each other may be input to the input unit 10. The input unit 10 may be configured to send the natural object data Ta and the artificial object data Tb thus received to the controller 80.

The controller 80 may be configured to, upon receiving the natural object data Ta and the artificial object data Tb, extract the natural object data Ia corresponding to the natural object data Ta and the artificial object data Ib corresponding to the artificial object data Tb, from the natural object data 34 and the artificial object data 35 in the storage 70. The controller 80 may be configured to send the natural object data Ia and the artificial object data Ib extracted from the storage 70 to the learning model 11.

Next, a description is given of a modification example of the list display procedure to be performed by the synthetic data generation system 2 according to the present application example. FIG. 37 illustrates a modification example of the list display procedure to be performed by the synthetic data generation system 2 according to the present application example.

First, the controller 80 may receive input of the natural object data Ta and the artificial object data Tb (Step S401). The controller 80 may convert the natural object data Ta and the artificial object data Tb thus received into the natural object data set Ia_set and the artificial object data Ib, respectively, using the natural object data 34 and the artificial object data 35 in the storage 70 (Step S402). The controller 80 may sequentially send the plurality of pieces of the natural object data Ia included in the natural object data set Ia_set obtained as a result of the conversion, one by one, to the learning model 11, and send the artificial object data Ib to the learning model 11 in accordance with the input of the natural object data Ia to the learning model 11. Upon receiving the natural object data Ia and the artificial object data Ib, the learning model 11 may generate and output the synthetic data Ic by combining the natural object data Ia and the artificial object data Ib thus received with each other. The learning model 11 may generate and output the synthetic data Ic, every time the natural object data Ia and the artificial object data Ib are received. The controller 80 may acquire a plurality of pieces of the synthetic data Ic, using the learning model 11(Step S403).

The controller 80 may cause the plurality of pieces of the synthetic data Ic obtained by the learning model 11 to be displayed in a list form (Step S404). The controller 80 may generate the interface IF3 in which the list of the plurality of pieces of the synthetic data Ic is displayed. The interface IF3 may display the synthetic data Ic selected by the user (the synthetic data Ic_select) and the synthetic data Ic not selected by the user (the synthetic data Ic_Non-select) in a distinguishable manner.

The interface IF3 may generate a selection flag for the synthetic data Ic_select, and a non-selection flag for the synthetic data Ic_Non-select. The interface IF3 may store a flag data set Flag_set including one or more selection flags and one or more non-selection flags thus generated in the storage 70, together with the plurality of pieces of the synthetic data Ic obtained by the learning model 11. The interface IF3 may store the one or more pieces of the synthetic data Ic_Non-select as the determination reference Dref3 in the storage 70. The interface IF3 may store a feature amount of the one or more pieces of the synthetic data Ic_Non-select as the determination reference Dref3 in the storage 70 (Step S405).

The controller 80 may receive input of the natural object data Ta and the artificial object data Tb (Step S406). The controller 80 may convert the natural object data Ta and the artificial object data Tb thus received into the natural object data Ia and the artificial object data Ib, respectively, using the natural object data 34 and the artificial object data 35 in the storage 70 (Step S407). The controller 80 may send the natural object data Ia and the artificial object data Ib obtained as a result of the conversion to the learning model 11. The controller 80 may acquire the synthetic data Ic, using the learning model 11 (Step S408).

The controller 80 may send the synthetic data Ic and one or more pieces of the synthetic data Ic_Non-select (the determination reference Dref3) to the learning model 13, and acquire the determination result Dx2 regarding the synthetic data Ic determined based on the determination reference Dref3 from the learning model 13. The controller 80 may acquire the determination result Dx2, using the learning model 13 (Step S409).

The controller 80 may determine whether the determination result Dx2 acquired from the learning model 13 satisfies the selection reference Dref4 (Step S410). If the determination result Dx2 satisfies the selection reference Dref4, the controller 80 may correlate the synthetic data Ic with the determination result Dx2 and store the synthetic data Ic in the storage 70 (Step S411). The controller 80 may perform the filtering based on the reference data 2H and determine whether the determination result Dx2 satisfies the selection reference Dref4, every time the synthetic data Ic is acquired. In this way, the controller 80 may store a plurality of pieces of the synthetic data Ic satisfying the selection reference Dref4 in the storage 70. The controller 80 may output the plurality of pieces of the synthetic data Ic satisfying the selection reference Dref4 and stored in the storage 70, as the synthetic data list IcL, to the display 50 (Step S412). The list display procedure may be performed by the synthetic data generation system 2 according to the present application example as described above.

In the present application example, the synthetic data generation system 2 according to the second example embodiment may be achieved by a single information processing apparatus. This allows the user to acquire a design (the synthetic data Ic) effective in creating ideas by inputting the natural object data set Ia_set or the natural object data Ia and the artificial object data Ib to the single information processing apparatus.

Alternatively, in the present application example, the synthetic data generation system 2 illustrated in FIG. 34 may be achieved by a terminal device 400 and a server apparatus 500 coupled via a communication network 600, as illustrated in FIG. 38, for example. The communication network 600 may be, for example, a wired local area network (LAN) such as Ethernet, a wireless LAN such as Wi-Fi, or a mobile-phone line.

The terminal device 400 may include, for example, the input unit 10, the display 50, a storage 410, a controller 420, and a communicator 430. The communicator 430 may include an interface configured to communicate with the server apparatus 500 via the communication network 600. The storage 410 may be a non-transitory tangible recording medium. The storage 410 may include, for example, a non-volatile memory such as an EEPROM, a flash memory, or a resistive random-access memory. The storage 410 may hold a program 411. The program 411 may include a series of processes to transmit the natural object data set Ia_set or the natural object data Ia and the artificial object data Ib received at the input unit 10 to the server apparatus 500 and to perform the data processing that causes the plurality of pieces of the synthetic data Ic satisfying the selection reference Dref4 and included in the synthetic data list IcL received from the server apparatus 500 to be displayed in a list form.

The controller 420 may be configured to, when the program 411 is loaded in the controller 420, perform a series of processes to transmit the natural object data set Ia_set or the natural object data Ia received at the input unit 10 and the artificial object data Ib received at the input unit 10 to the server apparatus 500 and to perform the data processing that causes the display 50 to display a list of the plurality of pieces of the synthetic data Ic satisfying the selection reference Dref4 and included in the synthetic data list IcL received from the server apparatus 500. The display 50 may be configured to display a list of the plurality of pieces of the synthetic data Ic included in the synthetic data list IcL.

The server apparatus 500 may include, for example, a communicator 510, storages 520 and 530, and a controller 540. The communicator 510 may include an interface configured to communicate with the terminal device 400 via the communication network 600. The storages 520 and 530 may be non-volatile tangible recording media. The storages 520 and 530 may be, for example, non-volatile memories, such as EEPROMs, flash memories, or resistive random-access memories.

The storage 520 may hold a program 521 and the learning models 11 and 13. The program 521 may include a series of processes to receive the natural object data set Ia_set or the natural object data Ia and the artificial object data Ib from the terminal device 400 and to generate the synthetic data list IcL using the natural object data set Ia_set or the natural object data Ia and the artificial object data Ib received from the terminal device 400. The storage 530 may hold the reference data 72. The storage 530 may further hold the reference data 71, the synthetic data 73, and the determination result 74.

The controller 540 may be configured to, when the program 521 is loaded in the controller 540, perform a series of processes to receive the natural object data set Ia_set or the natural object data Ia and the artificial object data Ib from the terminal device 400 and to generate the synthetic data Ic using the natural object data set Ia_set or the natural object data Ia received from the terminal device 400 and the artificial object data Ib received from the terminal device 400.

In a case where the synthetic data generation system 2 illustrated in FIG. 34 is achieved by the terminal device 400 and the server apparatus 500 coupled via the communication network 600 as described above, a relatively low-spec terminal device may be used as the terminal device 400. Further, the server apparatus 500 may be shared by a plurality of terminal devices 400, which allows additional terminal devices 400 to be added at a low cost.

Alternatively, in the present application example, the synthetic data generation system 2 illustrated in FIG. 36 may be achieved by the terminal device 400 and the server apparatus 500 coupled via the communication network 600, as illustrated in FIG. 39, for example. The storage 530 in the server apparatus 500 may hold the reference data 72, the natural object data 34, and the artificial object data 35. The storage 530 may further hold the reference data 71, the synthetic data 73, and the determination result 74.

In a case where the synthetic data generation system 2 illustrated in FIG. 36 is achieved by the terminal device 400 and the server apparatus 500 coupled via the communication network 600 as described above, a relatively low-spec terminal device may be used as the terminal device 400. Further, the server apparatus 500 may be shared by a plurality of terminal devices 400, which allows additional terminal devices 400 to be added at a low cost.

### 8. Third Example Embodiment

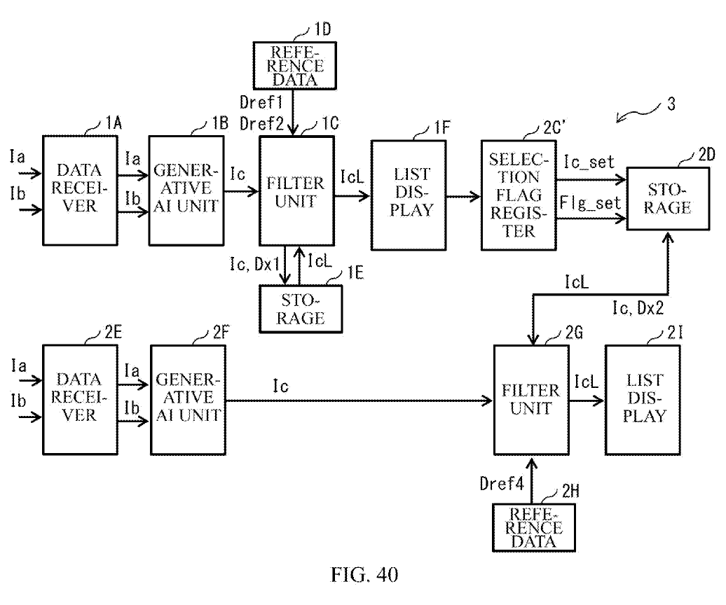

Next, a description is given of a synthetic data generation system 3 according to a third example embodiment of the disclosure. FIG. 40 is a block diagram illustrating an exemplary operation of the synthetic data generation system 3 according to the third example embodiment of the disclosure. As illustrated in FIG. 40, for example, the synthetic data generation system 3 may include the data receiver 1A, the generative AI unit 1B, the filter unit 1C, the reference data 1D, the storage 1E, the list display 1F, a selection flag register 2C', the storage 2D, the data receiver 2E, the generative AI unit 2F, the filter unit 2G, the reference data 2H, and the list display 2I.

The selection flag register 2C' may be configured to impart the functionality of the interface IF3 to the interface IF1. The interface IF1 to which the functionality of the interface IF3 is imparted (hereinafter simply referred to as an "interface IF1") may be configured to display the synthetic data Ic selected by the user (the synthetic data Ic_select) and the synthetic data Ic not selected by the user (the synthetic data Ic_Non-select) in a distinguishable manner, for example.

The interface IF1 may be configured to generate a selection flag for the synthetic data Ic_select, and a non-selection flag for the synthetic data Ic_Non-select. The interface IF1 may be configured to store a flag data set Flg_set including one or more selection flag and one or more non-selection flags thus generated in the storage 2D, together with the plurality of pieces of the synthetic data Ic obtained by the generative AI unit 2B.

The interface IF1 may be configured to store the one or more pieces of the synthetic data Ic_Non-select as the determination reference Dref3 in the reference data 2H. The interface IF1 may be configured to store a feature amount of the one or more pieces of the synthetic data Ic_Non-select as the determination reference Dref3 in the reference data 2H.

In the present example embodiment, upon receiving the natural object data Ia and the artificial object data Ib1, the learning model 11 may output the synthetic data Ic obtained by combining the natural object data Ia and the artificial object data Ib1 thus received with each other. Upon receiving the synthetic data Ic and the determination reference Dref3, the learning model 13 may output the determination result Dx2 regarding the synthetic data Ic determined based on the determination reference Dref3. Thereafter, the filter unit 2G may determine whether the determination result Dx2 satisfies the selection reference Dref4, and perform the data processing to cause a plurality of pieces of the synthetic data Ic satisfying the selection reference Dref4 to be displayed in a list form. This makes it possible to exclude an infeasible design quite different from the artificial object (item) that the user wants to design or a passable design without novelty in advance before the list is displayed. As a result, it is possible to present the user with a design effective in creating ideas.

In the present example embodiment, the synthetic data Ic correlated with the determination result Dx2 may be held in the storage 2D. This makes it possible to cause the synthetic data Ic newly acquired to be displayed in a list form together with the plurality of pieces of the synthetic data Ic determined to satisfy the selection reference Dref4 in the past determination result Dx2. As a result, it is possible to present the user with a plurality of designs (synthetic data Ic) effective in creating ideas.

In the present example embodiment, one or more pieces of the synthetic data Ic_Non-select or their feature amounts may be stored as the determination reference Dref3 in the reference data 2H. This makes it possible to exclude an infeasible design quite different from the artificial object (item) that the user wants to design or a passable design without novelty in advance before the list is displayed. As a result, it is possible to present the user with a design effective in creating ideas.

In the present example embodiment, the determination result Dx2 may be the data representing the first similarity or the second similarity described above, and the selection reference Dref4 may include the threshold of the first similarity or the threshold of the second similarity described above. This makes it possible to exclude an infeasible design quite different from the artificial object (item) that the user wants to design or a passable design without novelty in advance before the list is displayed. As a result, it is possible to present the user with a design effective in creating ideas.

### 9. Modification Example of Third Example Embodiment

Next, a description is given of a modification example of the synthetic data generation system 3 according to the third example embodiment.

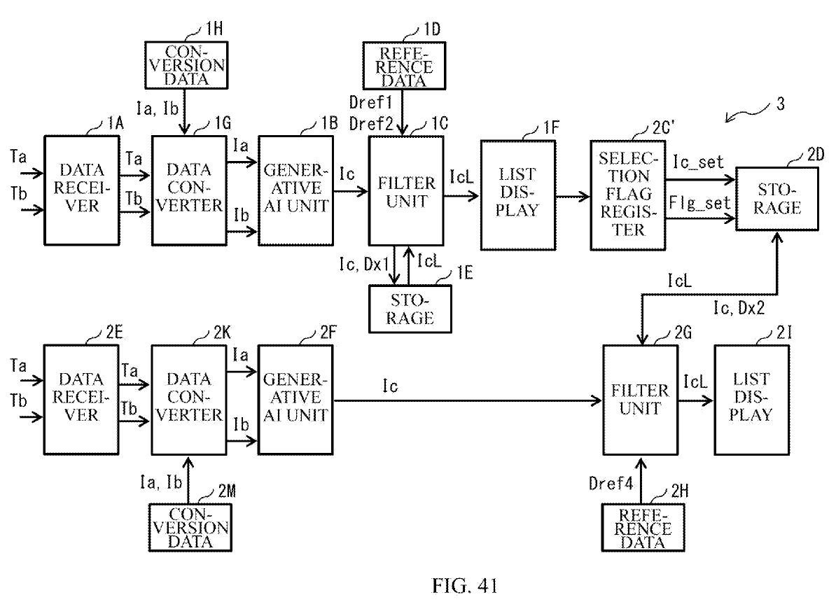

FIG. 41 is a block diagram illustrating a modification example of the operation of the synthetic data generation system 3. As illustrated in FIG. 41, for example, the synthetic data generation system 3 may include an interface configured to receive the natural object data Ta and the artificial object data Tb at the data receivers 1A and 2E. The natural object data Ta and the artificial object data Tb sharing a common data format with each other may be input to the data receivers 1A and 2E. The data receiver 1A may be configured to send the natural object data Ta and the artificial object data Tb thus received to the data converter 1G. The data receiver 2E may be configured to send the natural object data Ta and the artificial object data Tb thus received to the data converter 2K.

In the present modification example, the synthetic data generation system 3 may further include, as illustrated in FIG. 41, for example, data converters 1G and 2K and conversion data 1H and 2M. The data converter 1G may be configured to, upon receiving the natural object data Ta and the artificial object data Tb, convert the natural object data Ta and the artificial object data Tb thus received into the natural object data Ia and the artificial object data Ib, respectively, using the conversion data 1H. The data converter 1G may be configured to output the natural object data Ia and the artificial object data Ib obtained as a result of the conversion to the generative AI unit 1B.

In the present modification example, the natural object data Ta and the artificial object data Tb received at the data receiver 1A may be converted into the natural object data Ia and the artificial object data Ib, respectively, at the data converter 1G. Thereafter, the natural object data Ia and the artificial object data Ib obtained as a result of the conversion may be sent to the generative AI unit 2F. This allows the user to acquire the synthetic data Ic by simply inputting text data. As a result, it is possible to reduce the time and effort of the user in inputting data, and to present the user with a design effective in creating ideas.

### 10. Application Example

Next, a description is given of an application example of the synthetic data generation system 3 according to the third example embodiment and the modification example of the third example embodiment.

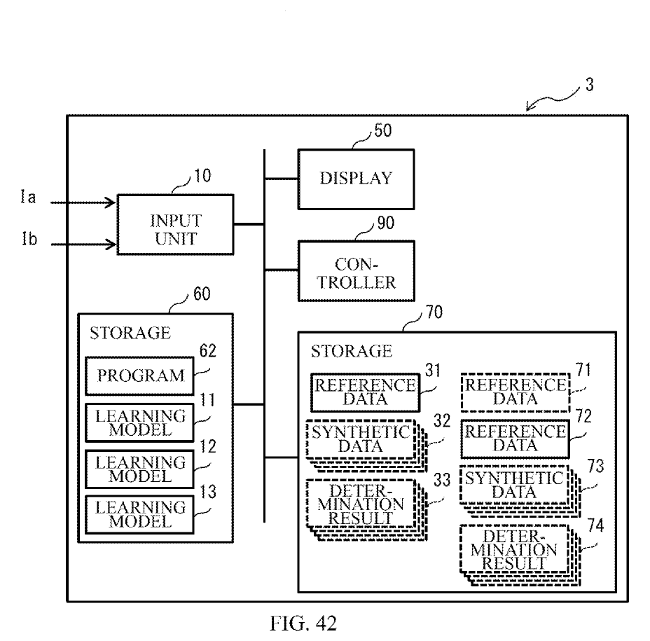

FIG. 42 illustrates an exemplary internal configuration of a single information processing apparatus to which the synthetic data generation system 3 according to the third example embodiment is applied. As illustrated in FIG. 42, for example, the synthetic data generation system 3 according to the present application example may include the input unit 10, the storage 60, the storage 70, a controller 90, and the display 50.

The input unit 10 may be configured to implement an operation similar to those of the data receivers 1A and 2E. The input unit 10 may include an interface configured to receive input of the natural object data Ia and the artificial object data Ib. The input unit 10 may be configured to send the natural object data Ia and the artificial object data Ib thus received to the controller 90.

As illustrated in FIG. 42, for example, the storage 60 may hold a program 62 and the learning models 11, 12, and 13. The program 62 may be a program that causes the controller 90 to implement a series of processes of the list display procedure to be performed by the synthetic data generation system 3 according to the present application example. In one embodiment, the program 62 may serve as the "synthetic data generation program". As illustrated in FIG. 42, for example, the storage 70 may hold the reference data 31 and 72. The storage 70 may further hold the reference data 71, the synthetic data 73, and the determination result 74.

The controller 90 may be configured to, when the program 62 is loaded in the controller 90, perform the series of processes of the list display procedure to be performed by the synthetic data generation system 3 according to the present application example. The controller 90 may be configured to implement an operation similar to those of the generative AI units 1B and 2F, using the learning model 11. The controller 90 may be configured to implement an operation similar to the filter unit 2G, using the learning models 12 and 13 and the reference data 71 and 72.

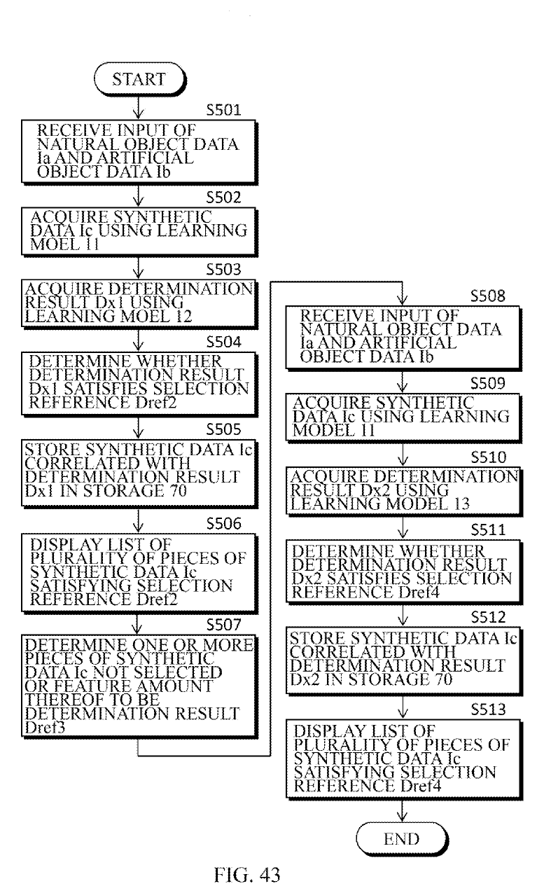

Next, a description is given of the list display procedure to be performed by the synthetic data generation system 3 according to the present application example. FIG. 43 illustrates an example of the list display procedure to be performed by the synthetic data generation system 3 according to the present application example.

First, the controller 90 may receive input of the natural object data Ia and the artificial object data Ib (Step S501). The controller 90 may send the natural object data Ia and the artificial object data Ib thus received to the learning model 11. The controller 90 may acquire the synthetic data Ic using the learning model 11 (Step S502). The controller 90 may send the synthetic data Ic and the determination reference Dref1 to the learning model 12. The controller 90 may acquire the determination result Dx1 using the learning model 12 (Step S503).

The controller 90 may determine whether the determination result Dx1 satisfies the selection reference Dref2 (Step S504). If the determination result Dx1 satisfies the selection reference Dref2, the controller 90 may correlate the synthetic data Ic with the determination result Dx1 and store the synthetic data Ic in the storage 70 (Step S505). The controller 90 may acquire the determination result Dx1 using the learning model 12, every time the synthetic data Ic is acquired, and if the determination result Dx1 satisfies the selection reference Dref2, correlate the synthetic data Ic with the determination result Dx1 and store the synthetic data Ic in the storage 70. In this way, the controller 90 may store a plurality of pieces of the synthetic data Ic satisfying the selection reference Dref2 in the storage 70.

The controller 90 may output the plurality of pieces of the synthetic data Ic satisfying the selection reference Dref2 and stored in the storage 70, as the synthetic data list IcL, to the display 50. The display 50 may generate the interface IF1 including an image of a list of the plurality of pieces of the synthetic data Ic included in the synthetic data list IcL. In this way, the display 50 may display the list of the plurality of pieces of the synthetic data Ic satisfying the selection reference Dref2 (Step S506). The list display procedure may be performed by the synthetic data generation system 3 according to the present application example as described above.

The interface IF1 may generate a selection flag for the synthetic data Ic_select, and a non-selection flag for the synthetic data Ic_Non-select. The interface IF1 may store a flag data set Flag_set including one or more selection flags and one or more non-selection flags thus generated in the storage 70, together with the plurality of pieces of the synthetic data Ic. The interface IF1 may store the one or more pieces of the synthetic data Ic_Non-select as the determination reference Dref3 in the storage 70. The interface IF1 may store a feature amount of the one or more pieces of the synthetic data Ic_Non-select as the determination reference Dref3 in the storage 70 (Step S507).

The controller 90 may receive input of the natural object data Ia and the artificial object data Ib (Step S508). The controller 90 may send the natural object data Ia and the artificial object data Ib thus received to the learning model 11. The controller 90 may acquire the synthetic data Ic using the learning model 11 (Step S509). The controller 90 may send the synthetic data Ic and one or more pieces of the synthetic data Ic_Non-select (the determination reference Dref3) to the learning model 13, and acquire the determination result Dx2 regarding the synthetic data Ic determined based on the determination reference Dref3 from the learning model 13. The controller 90 may acquire the determination result Dx2 using the learning model 13 (Step S510).

The controller 90 may determine whether the determination result Dx2 acquired from the learning model 13 satisfies the selection reference Dref4 (Step S511). If the determination result Dx2 satisfies the selection reference Dref4, the controller 90 may correlate the synthetic data Ic with the determination result Dx2 and store the synthetic data Ic in the storage 70 (Step S512). The controller 90 may perform the filtering based on the reference data 2H and determine whether the determination result Dx2 satisfies the selection reference Dref4, every time the synthetic data Ic is acquired. In this way, the controller 90 may store a plurality of pieces of the synthetic data Ic satisfying the selection reference Dref4 in the storage 70. The controller 90 may output the plurality of pieces of the synthetic data Ic satisfying the selection reference Dref4 and stored in the storage 70, as the synthetic data list IcL, to the display 50 (Step S513). The list display procedure may be performed by the synthetic data generation system 3 according to the present application example as described above.

In the present application example, the synthetic data generation system 3 according to the third example embodiment may be achieved by a single information processing apparatus. This allows the user to acquire a design (the synthetic data Ic) effective in creating ideas by inputting the natural object data Ia and the artificial object data Ib to the single information processing apparatus.

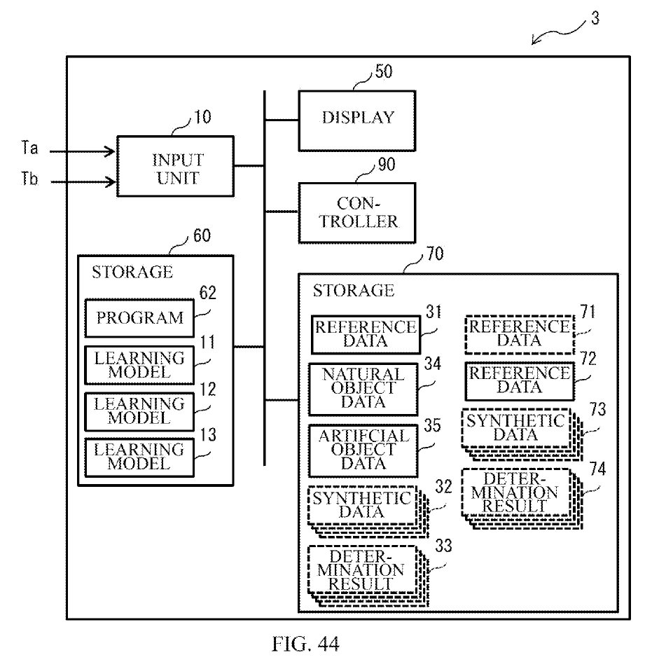

Alternatively, in the present application example, the single information processing apparatus may receive input of the natural object data Ta and the artificial object data Tb, as illustrated in FIG. 44, for example. In this case, the storage 70 may further hold the natural object data 34 and the artificial object data 35.

The input unit 10 may have an interface configured to receive input of the natural object data Ta and the artificial object data Tb. The natural object data Ta and the artificial object data Tb sharing a common data format with each other may be input to the input unit 10. The input unit 10 may be configured to send the natural object data Ta and the artificial object data Tb thus received to the controller 90.

The controller 90 may be configured to, upon receiving the natural object data Ta and the artificial object data Tb, extract the natural object data Ia corresponding to the natural object data Ta and the artificial object data Ib corresponding to the artificial object data Tb, from the natural object data 34 and the artificial object data 35 in the storage 70. The controller 90 may be configured to send the natural object data Ia and the artificial object data Ib extracted from the storage 70 to the learning model 11.

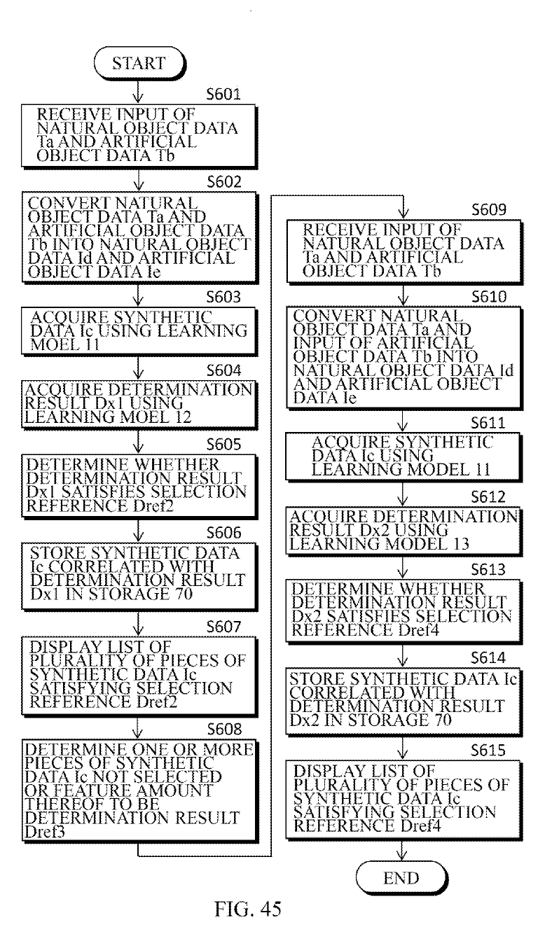

Next, a description is given of a modification example of the list display procedure to be performed by the synthetic data generation system 3 according to the present application example. FIG. 45 illustrates the modification example of the list display procedure to be performed by the synthetic data generation system 3 according to the present modification example.

First, the controller 90 may receive input of the natural object data Ta and the artificial object data Tb (Step S601). The controller 90 may convert the natural object data Ta and the artificial object data Tb thus received into the natural object data Ia and the artificial object data Ib, respectively, using the natural object data 34 and the artificial object data 35 in the storage 70 (Step S602). The controller 90 may send the natural object data Ia and the artificial object data Ib obtained as a result of the conversion to the learning model 11. Upon receiving the natural object data Ia and the artificial object data Ib, the learning model 11 may generate and output the synthetic data Ic by combining the natural object data Ia and the artificial object data Ib thus received with each other. The learning model 11 may generate and output the synthetic data Ic, every time the natural object data Ia and the artificial object data Ib are received. The controller 90 may acquire a plurality of pieces of the synthetic data Ic, using the learning model 11 (Step S603).

The controller 90 may send the synthetic data Ic and the determination reference Dref1 to the learning model 12. The controller 90 may acquire the determination result Dx1, using the learning model 12 (Step S604). The controller 90 may determine whether the determination result Dx1 satisfies the selection reference Dref2 (Step S605). If the determination result Dx1 satisfies the selection reference Dref2, the controller 90 may correlate the synthetic data Ic with the determination result Dx1 and store the synthetic data Ic in the storage 70 (Step S606). The controller 90 may acquire the determination result Dx1, using the learning model 12, every time the synthetic data Ic is acquired, and if the determination result Dx1 satisfies the selection reference Dref2, correlate the synthetic data Ic with the determination result Dx1 and store the synthetic data Ic in the storage 70. In this way, the controller 90 may store a plurality of pieces of the synthetic data Ic satisfying the selection reference Dref2 in the storage 70.

The controller 90 may output the plurality of pieces of the synthetic data Ic satisfying the selection reference Dref2 and stored in the storage 70, as the synthetic data list IcL, to the display 50. The display 50 may generate the interface IF1 including an image of a list of the plurality of pieces of the synthetic data Ic included in the synthetic data list IcL. In this way, the display 50 may display the list of the plurality of pieces of the synthetic data Ic satisfying the selection reference Dref2 (Step S607). The list display procedure may be performed by the synthetic data generation system 3 according to the present application example as described above.

The interface IF1 may generate a selection flag for the synthetic data Ic_select, and a non-selection flag for the synthetic data Ic_Non-select. The interface IF1 may store a flag data set Flag_set including one or more selection flags and one or more non-selection flags thus generated in the storage 70, together with the plurality of pieces of the synthetic data Ic. The interface IF1 may store the one or more pieces of the synthetic data Ic_Non-select as the determination reference Dref3 in the storage 70. The interface IF1 may store a feature amount of the one or more pieces of the synthetic data Ic_Non-select as the determination reference Dref3 in the storage 70 (Step S608).

The controller 90 may receive input of the natural object data Ta and the artificial object data Tb (Step S609). The controller 90 may convert the natural object data Ta and the artificial object data Tb thus received into the natural object data Ia and the artificial object data Ib, respectively, using the natural object data 34 and the artificial object data 35 in the storage 70 (Step S610). The controller 90 may send the natural object data Ia and the artificial object data Ib obtained as a result of the conversion to the learning model 11. The controller 90 may acquire the synthetic data Ic, using the learning model 11 (Step S611). The controller 90 may send the synthetic data Ic and one or more pieces of the synthetic data Ic_Non-select (the determination reference Dref3) to the learning model 13, and acquire the determination result Dx2 regarding the synthetic data Ic determined based on the determination reference Dref3, from the learning model 13. The controller 90 may acquire the determination result Dx2, using the learning model 13 (Step S612).

The controller 90 may determine whether the determination result Dx2 acquired from the learning model 13 satisfies the selection reference Dref4 (Step S613). If the determination result Dx2 satisfies the selection reference Dref4, the controller 90 may correlate the synthetic data Ic with the determination result Dx2 and store the synthetic data Ic in the storage 70 (Step S614). The controller 90 may perform the filtering based on the reference data 2H and determine whether the determination result Dx2 satisfies the selection reference Dref4, every time the synthetic data Ic is acquired. In this way, the controller 90 may store a plurality of pieces of the synthetic data Ic satisfying the selection reference Dref4 in the storage 70. The controller 90 may send the plurality of pieces of the synthetic data Ic satisfying the selection reference Dref4 and stored in the storage 70, as the synthetic data list IcL, to the display 50 (Step S615). The list display procedure may be performed by the synthetic data generation system 3 according to the present application example as described above.

In the present application example, the synthetic data generation system 3 according to the third example embodiment may be achieved by a single information processing apparatus. This allows the user to acquire a design (the synthetic data Ic) effective in creating ideas by inputting the natural object data Ia and the artificial object data Ib to the single information processing apparatus.

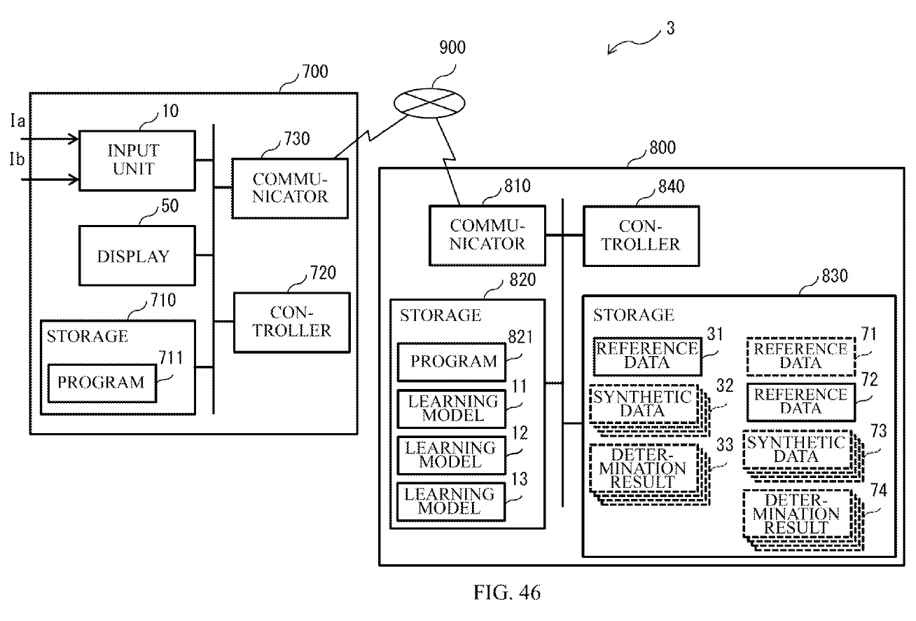

Alternatively, in the present application example, the synthetic data generation system 3 illustrated in FIG. 42 may be achieved by a terminal device 700 and a server apparatus 800 coupled via a communication network 900, as illustrated in FIG. 46, for example. The communication network 900 may be, for example, a wired local area network (LAN) such as Ethernet, a wireless LAN such as Wi-Fi, or a mobile-phone line.

The terminal device 700 may include, for example, the input unit 10, the display 50, a storage 710, a controller 720, and a communicator 730. The communicator 730 may include an interface configured to communicate with the server apparatus 800 via the communication network 900. The storage 710 may be a non-transitory tangible recording medium. The storage 710 may include, for example, a non-volatile memory such as an EEPROM, a flash memory, or a resistive random-access memory. The storage 710 may hold a program 711. The program 711 may include a series of processes to transmit the natural object data Ia and the artificial object data Ib received at the input unit 10 to the server apparatus 800 and to perform the data processing that causes the plurality of pieces of the synthetic data Ic satisfying the selection reference Dref4 and included in the synthetic data list IcL received from the server apparatus 800 to be displayed in a list form.

The controller 720 may be configured to, when the program 711 is loaded in the controller 720, perform a series of processes to transmit the natural object data Ia and the artificial object data Ib received at the input unit 10 to the server apparatus 800 and to perform the data processing that causes the display 50 to display a list of the plurality of pieces of the synthetic data Ic satisfying the selection reference Dref4 and included in the synthetic data list IcL received from the server apparatus 800. The display 50 may be configured to display a list of the plurality of pieces of the synthetic data Ic included in the synthetic data list IcL.

The server apparatus 800 may include, for example, a communicator 810, storages 820 and 830, and a controller 840. The communicator 810 may include an interface configured to communicate with the terminal device 700 via the communication network 900. The storages 820 and 830 may be non-volatile tangible recording media. The storages 820 and 830 may be, for example, non-volatile memories, such as EEPROMs, flash memories, or resistive random-access memories.

The storage 820 may hold a program 821 and the learning models 11, 12, and 13. The program 821 may include a series of processes to receive the natural object data Ia and the artificial object data Ib from the terminal device 700 and to generate the synthetic data list IcL using the natural object data Ia and the artificial object data Ib received from the terminal device 700. The storage 830 may hold the reference data 31 and 72. The storage 830 may further hold the reference data 71, the synthetic data 32 and 73, and the determination results 33 and 74.

The controller 840 may be configured to, when the program 821 is loaded in the controller 840, perform a series of processes to receive the natural object data Ia and the artificial object data Ib from the terminal device 700 and to generate the synthetic data Ic using the natural object data Ia and the artificial object data Ib received from the terminal device 700.

In a case where the synthetic data generation system 3 illustrated in FIG. 42 is achieved by the terminal device 700 and the server apparatus 800 coupled via the communication network 900 as described above, a relatively low-spec terminal device may be used as the terminal device 700. Further, the server apparatus 800 may be shared by a plurality of terminal devices 700, which allows additional terminal devices 700 to be added at a low cost.

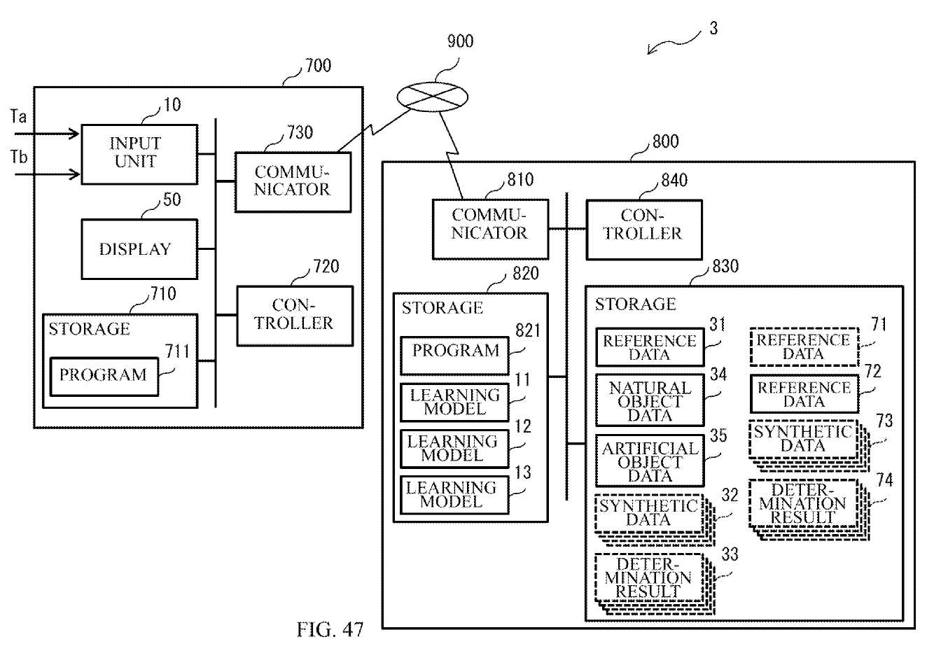

Alternatively, in the present application example, the synthetic data generation system 3 illustrated in FIG. 44 may be achieved by the terminal device 700 and the server apparatus 800 coupled via the communication network 900, as illustrated in FIG. 47, for example. The storage 830 in the server apparatus 800 may hold the reference data 31 and 72, the natural object data 34, and the artificial object data 35. The storage 830 may further hold the reference data 71, the synthetic data 32 and 73, and the determination results 33 and 74.

In a case where the synthetic data generation system 3 illustrated in FIG. 44 is achieved by the terminal device 700 and the server apparatus 800 coupled via the communication network 900 as described above, a relatively low-spec terminal device may be used as the terminal device 700. Further, the server apparatus 800 may be shared by a plurality of terminal devices 700, which allows additional terminal devices 700 to be added at a low cost.

It is to be noted that the effects described herein are mere examples, and effects of the disclosure are not limited to those described herein. Other effects of the disclosure may thus be provided.

Further, the disclosure may have the following aspects.

(1) A synthetic data generation system including:

a first learning model configured to output synthetic data upon receiving one or more first data items and a second data item, the synthetic data being a combination of the one or more first data items or one or more third data items corresponding to the one or more first data items and the second data item or a fourth data item corresponding to the second data item;

a second learning model configured to output a determination result upon receiving the synthetic data acquired from the first learning model and a determination reference, the determination result being a result of a determination regarding the synthetic data based on the determination reference; and

a processor configured to determine whether the determination result satisfies a predetermined selection reference, and perform data processing to cause a plurality of pieces of the synthetic data satisfying the predetermined selection reference to be displayed in a list form.

(2) The synthetic data generation system according to (1), in which the one or more first data items include one or more two-dimensional image data items, one or more three-dimensional image data items, or one or more three-dimensional model data items including a first target object,

the second data includes one or more two-dimensional image data items, one or more three-dimensional image data items, or one or more three-dimensional model data items including a second target object,

the synthetic data is the combination of the one or more first data items and the second data item, and includes one or more two-dimensional image data items, one or more three-dimensional image data items, or one or more three-dimensional model data items including a product generated by the first learning model, and

the one or more first data items, the second data item, and the synthetic data share a common data format with one another.

(3) The synthetic data generation system according to (2), in which when the one or more first data items include the one two-dimensional image data item, the one three-dimensional image data item, or the one three-dimensional image data item including the first target object,

the first target object is a natural object, and

the second target object is an artificial object.

(4) The synthetic data generation system according to (2), in which when the one or more first data items include the two-dimensional image data items, the three-dimensional image data items, or the three-dimensional image data items including the first target object,

the first target objects included in the two-dimensional image data items, the three-dimensional image data items, or the three-dimensional image data items are natural objects different from each other.

(5) The synthetic data generation system according to (1), in which the one or more first data items include one or more first text data items representing a first target object,

the second data item includes a second text data item representing a second target object,

the one or more third data items include one or more two-dimensional image data items, one or more three-dimensional image data items, or one or more three-dimensional model data items including the first target object,

the fourth data item includes one or more two-dimensional image data items, one or more three-dimensional image data items, or one or more three-dimensional model data items including the second target object,

the synthetic data includes the combination of the one or more third data items and the fourth data item, and includes one or more two-dimensional image data items, one or more three-dimensional image data items, or one or more three-dimensional model data items including a product generated by the first learning model, and

the one or more third data items, the fourth data item, and the synthetic data share a common data format with one another.

(6) The synthetic data generation system according to (5), in which when the one or more first data items are the one first text data item representing the first targe object,

the first target object is a natural object, and

the second target object is an artificial object.

(7) The synthetic data generation system according to (5), in which when the one or more first data items are the first text data items representing the first targe object,

the first target objects included in the first text data items are natural objects different from one another, and

the second target object is an artificial object.

(8) The synthetic data generation system according to any one of (1) to (7), in which the determination reference includes a term indicating whether the product included in the synthetic data looks like the second targe object.

(9) The synthetic data generation system according to any one of (8), in which the predetermined selection reference includes a first selection reference indicating that the product included in the synthetic data does not look like the second target object.

(10) The synthetic data generation system according to (8), in which the predetermined selection reference includes a second selection reference indicating that the product included in the synthetic looks like the second target object.

(11) The synthetic data generation system according to any one of (1) to (7), in which

the processor is configured to store one or more pieces of non-selection data not selected out of the plurality of pieces of the synthetic data output from the first learning model or a feature amount of the one or more pieces of the non-selection data in a storage, and

the determination reference includes the one or more pieces of the non-selection data or the feature amount of the one or more pieces of the non-selection data stored in the storage.

(12) The synthetic data generation system according to any one of (11), in which

the determination result is data representing first similarity of the synthetic data acquired from the first learning model with the non-selection data, or data representing second similarity of a feature amount of the synthetic data acquired from the first learning model with the feature amount of the non-selection data, and

the determination reference includes the one or more pieces of the non-selection data stored in the storage or the feature amount of the one or more pieces of the non-selection data.

(13) The synthetic data generation system according to any one of (1) to (12), in which the processor is configured to store the synthetic data and the determination result in correlation with each other in the storage.

(14) A non-transitory computer readable recording medium containing a synthetic data generation program that causes, when executed by a computer, the computer to implement a method, the method including:

receiving one or more first data items and a second data item;

acquiring synthetic data from a first learning model by sending the one or more first data items and the second data item to the first learning model, the synthetic data being a combination of the one or more first data items or one or more third data items corresponding to the one or more first data items and the second data item or a fourth data item corresponding to the second data item;

acquiring a determination result regarding the synthetic data determined based on a determination reference from a second learning model by sending the synthetic data acquired from first learning model and the determination reference to the second learning model; and

determining whether the determination result satisfies a predetermined selection reference, and performing data processing that causes a plurality of pieces of the synthetic data satisfying the predetermined selection reference to be displayed in a list form.

(15) The non-transitory computer readable recording medium according to (14) that causes, when executed by the computer, the computer to implement a method, the method including storing the two-dimensional image data item, the three-dimensional image data item, or the three-dimensional model data item in correlation with the determination result in the storage.

One of more of the synthetic data generation system 1 illustrated in FIGS. 1, 9, 13, 17, and 18, the synthetic data generation system 2 illustrated in FIGS. 25, 32, 33, 34, and 35, the synthetic data generation system 3 illustrated in FIGS. 42 and 43, the controller 40 illustrated in FIGS. 19 and 21, the controller 120 illustrated in FIGS. 23 and 24, the controller 80 illustrated in FIG. 36, the controller 420 illustrated in FIGS. 38 and 39, the controller 540 illustrated in FIGS. 38 and 39, the controller 90 illustrated in FIG. 42, the controller 720 illustrated in FIGS. 46 and 47, and the controller 840 illustrated in FIGS. 46 and 47 (hereinafter referred to as the synthetic data generation system 1 and the like) are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the synthetic data generation system 1 and the like. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the synthetic data generation system 1 and the like.

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

1. A synthetic data generation system comprising:
a first learning model configured to output synthetic data upon receiving one or more first data items and a second data item, the synthetic data comprising a combination of the one or more first data items or one or more third data items corresponding to the one or more first data items and the second data item or a fourth data item corresponding to the second data item;
a second learning model configured to output a determination result upon receiving the synthetic data acquired from the first learning model and a determination reference, the determination result comprising a result of a determination regarding the synthetic data based on the determination reference; and
a processor configured to determine whether the determination result satisfies a predetermined selection reference, and perform data processing to cause a plurality of pieces of the synthetic data satisfying the predetermined selection reference to be displayed in a list form.

2. The synthetic data generation system according to claim 1, wherein
the one or more first data items comprise one or more two-dimensional image data items, one or more three-dimensional image data items, or one or more three-dimensional model data items comprising a first target object,
the second data comprises one or more two-dimensional image data items, one or more three-dimensional image data items, or one or more three-dimensional model data items comprising a second target object,
the synthetic data comprises the combination of the one or more first data items and the second data item and comprises one or more two-dimensional image data items, one or more three-dimensional image data items, or one or more three-dimensional model data items comprising a product generated by the first learning model, and
the one or more first data items, the second data item, and the synthetic data share a common data format with one another.

3. The synthetic data generation system according to claim 1, wherein
the one or more first data items comprise one or more first text data items representing a first target object,
the second data item comprises a second text data item representing a second target object,
the one or more third data items comprise one or more two-dimensional image data items, one or more three-dimensional image data items, or one or more three-dimensional model data items comprising the first target object,
the fourth data item comprises one or more two-dimensional image data items, one or more three-dimensional image data items, or one or more three-dimensional model data items comprising the second target object,
the synthetic data comprises the combination of the one or more third data items and the fourth data item and comprises one or more two-dimensional image data items, one or more three-dimensional image data items, or one or more three-dimensional model data items comprising a product generated by the first learning model, and
the one or more third data items, the fourth data item, and the synthetic data share a common data format with one another.

4. The synthetic data generation system according to claim 1, wherein
the processor is configured to store one or more pieces of non-selection data not selected out of the plurality of pieces of the synthetic data output from the first learning model or a feature amount of the one or more pieces of the non-selection data in a storage, and
the determination reference comprises the one or more pieces of the non-selection data or the feature amount of the one or more pieces of the non-selection data stored in the storage.

5. A non-transitory computer readable recording medium containing a synthetic data generation program that causes, when executed by a computer, the computer to implement a method, the method comprising:
receiving one or more first data items and a second data item;
acquiring synthetic data from a first learning model by sending the one or more first data items and the second data item to the first learning model, the synthetic data comprising a combination of the one or more first data items or one or more third data items corresponding to the one or more first data items and the second data item or a fourth data item corresponding to the second data item;
acquiring a determination result regarding the synthetic data determined based on a determination reference from a second learning model by sending the synthetic data acquired from first learning model and the determination reference to the second learning model; and
determining whether the determination result satisfies a predetermined selection reference, and performing data processing that causes a plurality of pieces of the synthetic data satisfying the predetermined selection reference to be displayed in a list form.
